(19) United States
(12) Patent Application Publication
(10) Pub. No.: US 2015/0275566 A1
(43) Pub. Date: Oct. 1, 2015

(54) REFLECTING MIRROR POSTURE ADJUSTMENT STRUCTURE, CEILING PLATE OPENING AND CLOSING MECHANISM, AND INSPECTION DEVICE

(71) Applicant: EBARA CORPORATION, Tokyo (JP)

(72) Inventor: Matsutaro MIYAMOTO, Tokyo (JP)

(21) Appl. No.: 14/668,050

(22) Filed: Mar. 25, 2015

(30) Foreign Application Priority Data
Mar. 27, 2014 (JP) 2014-065716
May 9, 2014 (JP) 2014-097911

(51) Int. Cl. E06B 3/52; E06B 5/00; E05F 15/50; G02B 7/182; G01B 9/02

(52) U.S. Cl. CPC E06B 3/52; G02B 7/1824; G01B 9/02; E05F 15/50; E06B 5/00

(57) ABSTRACT

Provided is a reflecting mirror holding mechanism including: a base that is obtained by integrally forming a fixed portion fixed onto an attachment table and a movable portion including a notched portion having a narrow width; a reflecting mirror holder that holds a reflecting mirror and is fixed to the front end of the base; and a gap width adjustment member that adjusts the gap width of the notched portion of the base, wherein the inclining degree of the reflecting mirror held by the reflecting mirror holder is adjusted when the gap width of the notched portion is decreased or increased by the manipulation of the gap width adjustment member.

### CROSS-REFERENCE TO RELATED APPLICATIONS

This application claims the benefit of Japanese Priority Patent Applications JP 2014-065716 filed on Mar. 27, 2014 and JP 2014-097911 filed on May 9, 2014, the entire contents of which are incorporated herein by reference.

### FIELD

The present invention relates to an inspection device and a structure for adjusting the posture of a reflecting mirror and a mechanism for opening and closing a ceiling plate (an upper plate) of a container used in the inspection device.

### BACKGROUND AND SUMMARY

A semiconductor fabrication device that performs treatment on a material or an inspection device that inspects a sample is equipped with a stage that holds a material or a sample as treatment or inspection target and moves the material or the sample to an arbitrary position. Generally, the uppermost portion of the stage is provided with a table including a holding unit such as an electrostatic chuck that holds a material or a sample, and a reflecting mirror as a length measurement target of a length measurement unit (which is generally an optical length measurement unit such as a laser interferometer) that measures the length of the table at the current position.

Then, the material or the sample which is held by the table is highly precisely controlled and displaced in terms of feedback control for a stage driving source based on a length measurement value detected by the length measurement unit (for example, see JP 5-315221 A).

Further, in a structure that supports a displacement sensor of an interference device, a structure is known in which a displacement sensor is fixed and supported to a base with a notched portion for adjusting the distortion caused by thermal expansion in order to reduce a thermal influence degree between the displacement sensor and an attachment member thereof (for example, see JP 2004-125638 A and JP 2005-114607 A).

Further, in a semiconductor fabrication device that performs fine treatment on a treatment target or an inspection device that inspects a fine treatment product, a stage which holds the target and moves to an arbitrary position is used commonly. Here, there is a case where the semiconductor needs to be treated or inspected in a vacuum state. In that case, the stage is disposed inside a container (a chamber) capable of maintaining a vacuum state.

In the case where the repair or the maintenance of the stage is performed due to the failure of the stage, a worker needs to access the stage disposed inside the container. In the container of the related art, an opening and closing door is provided at the side surface portion of the container so that a worker may access the stage. Further, in a certain container, an opening is provided in a part of the container, is covered by a lid in a normal case, and is opened by the separation of the lid if necessary.

Further, in another container, the entire ceiling plate (upper plate) is opened (a ceiling plate opening operation) so that a worker may access the stage as much as possible. In this case, the ceiling plate may be opened after the ceiling plate is moved upward and is moved laterally. However, since the ceiling plate is generally heavy and rectangular, an upward movement member is provided which has four upward movement support points of the ceiling plate. Due to this configuration, a synchronization mechanism capable of synchronizing the four upward movement support points is generally needed in order to horizontally maintain the posture of the ceiling plate. As the related art thereof, JP 7-165066 A discloses that a part of an inspection device is moved by a mechanical unit.

An object of the present application is to provide a reflecting mirror posture adjustment structure and a ceiling plate opening and closing mechanism.

According to an embodiment of the invention, provided is a reflecting mirror posture adjustment structure including: a base that is obtained by integrally forming a fixed portion fixed onto an attachment table and a movable portion including a slit-shaped notched portion having a narrow width; a reflecting mirror holder that holds a reflecting mirror and is fixed to the front end of the movable portion of the base; and a gap width adjustment member that adjusts the width of the gap of the notched portion of the base, wherein the inclining degree of the reflecting mirror held by the reflecting mirror holder is adjusted when the gap width is decreased or increased by the manipulation of the gap width adjustment member.

Accordingly, since the base provided with the reflecting mirror holder is obtained by integrally forming the fixed portion and the movable portion with each other, the base may be attached to a narrow installation space in a compact size. Further, since the base is formed in a single block state, the original rigidity of the material may be maintained, and hence the fixed portion and the movable portion of the base may have high rigidity.

Further, since the gap width adjustment member which adjusts the gap width of the notched portion of the base is provided, the posture of the reflecting mirror may be easily adjusted by the adjustment of the gap width of the notched portion through the gap width adjustment member.

In the above-described configuration, the base may include at least a first movable portion in which a notched portion is disposed in a direction perpendicular to the lower surface of the fixed portion fixed onto the attachment table and a second movable portion in which a notched portion is disposed in a parallel direction.

When a plurality of notched portions having different notch directions is provided in the base and the gap widths of the notched portions are adjusted, the reflecting mirror may be highly precisely adjusted in a desired posture.

In the above-described configuration, female tapered portions which are depressed downward may be respectively provided in the facing surfaces inside the notched portion of the first movable portion, the gap width adjustment member of which the outer peripheral surface is provided with a male tapered portion fitted to the female tapered portions may be fitted to the female tapered portions from the upside thereof, and a screw portion provided in the front end of the gap width adjustment member may be threaded and fixed into a screw hole provided in an attachment table overlapping the lower side of the first movable portion. Then, the gap width of the notched portion of the first movable portion may be adjusted when the threading depth of the screw portion of the gap width adjustment member is changed.

If the male/female taper shape is combined in this way, an adjustment force may be generated in a direction perpendicular to the direction of the shaft force generated, for example, when a bolt-type gap width adjustment member is threaded, and hence the manipulation direction for the adjustment may be set to one direction. Further, the reflecting mirror may be more highly precisely adjusted in accordance with the setting of the angle of the tapered portion.

Further, in the above-described configuration, the second movable portion may be formed by a lower movable piece and an upper movable piece facing the notched portion. Then, the upper surface of the upper movable piece may be provided with the gap width adjustment member including a pulling bolt of which a shaft portion penetrates the upper movable piece and is threaded into a screw hole provided in the lower movable piece and a pushing bolt of which a shaft portion is threaded into a screw hole provided in the upper movable piece and the end of the shaft portion is bonded to the upper surface of the lower movable piece. Further, a shaft portion of a fixing bolt is threaded and fixed into the screw hole provided in the attachment table overlapping the lower side of the second movable portion while penetrating the upper movable piece and the lower movable piece in the vicinity of the gap width adjustment member. Furthermore, the gap width of the notched portion of the second movable portion may be adjusted when the threading depth of the pulling bolt of the gap width adjustment member in the lower movable piece and the threading depth of the pushing bolt thereof in the upper movable piece are changed.

In this way, since the movable portion is fixed by the fixing bolt in the vicinity of the pulling bolt or the pushing bolt of the gap width adjustment member, the adjustment state may be rigidly maintained, and hence the state maintaining rigidity is improved. Thus, the reflecting mirror may be stably maintained in an adjusted posture without causing a change in time.

Further, in the case where the reflecting mirror is provided in a vacuum state, an access mechanism that includes a vacuum seal function and adjusts the gap width adjustment member may be provided above the base, and the inclining degree of the reflecting mirror provided in a vacuum state may be adjusted by the manipulation of the access mechanism at the atmosphere side.

When the posture of the reflecting mirror in a vacuum state may be adjusted by the access mechanism including a vacuum seal function, the reflecting mirror posture adjustment structure may be applied to a reflecting mirror of an electron beam application device disposed in a vacuum state.

According to an embodiment of the invention, provided is a ceiling plate opening and closing mechanism that opens and closes a rigid ceiling plate of a container including a container body and the ceiling plate, the ceiling plate opening and closing mechanism including: an upward movement member that moves the ceiling plate upward while supporting the ceiling plate at three support points from the downside.

By this configuration, since the ceiling plate is moved upward while being supported at three points, the load of the ceiling plate is normally applied to all support points differently from the case where the ceiling plate is supported at four or more support points. Thus, it is possible to suppress behavior in which the ceiling plate is moved upward in an inclined state and hence to horizontally move the ceiling plate upward. That is, in the case where the number of the support points is four or more, the load is normally applied to three points among four or more points, but the load is not applied to one or more points. Since the plane is uniquely determined by three points and the ceiling plate is rigid, the ceiling plate is supported in a plane when the ceiling plate is supported at three points, and hence the load of the ceiling plate is normally applied to three points.

In the ceiling plate opening and closing mechanism, the upward movement member may correspond to three hydraulic jacks that are operated by a common hydraulic pump and support the three support points of the ceiling plate from the downside.

By this configuration, since the load of the ceiling plate is normally applied to three hydraulic jacks, it is possible to prevent a phenomenon in which the hydraulic pressure of the hydraulic jack not receiving the load is released, the ceiling plate is inclined, the load is intensively applied to the hydraulic jack receiving the load, and then the ceiling plate is further inclined. Thus, it is possible to horizontally move the ceiling plate upward.

The ceiling plate opening and closing mechanism may further include a lateral movement mechanism that laterally moves the ceiling plate moved upward by the upward movement member.

By this configuration, since the container is opened by removing the ceiling plate from the upside of the container body, a worker may easily access the inside of the container during the repair or the maintenance.

In the ceiling plate opening and closing mechanism, the lateral movement mechanism may include a ceiling plate placement table that places the moved ceiling plate thereon while being adjacent to the container body, and the ceiling plate may be movable onto the ceiling plate placement table.

By this configuration, since the lateral movement mechanism moves the ceiling plate to the ceiling plate placement table, it is possible to stably hold the ceiling plate removed from the container.

In the ceiling plate opening and closing mechanism, the lateral movement mechanism may include a wheeled platform which places the ceiling plate thereon and moves in the lateral direction. Then, the wheeled platform may be inserted below the ceiling plate moved upward by the upward movement member, and the ceiling plate may be moved downward so that the ceiling plate is placed on the wheeled platform.

By this configuration, the lateral movement mechanism may open the ceiling plate in a manner such that the ceiling plate is placed on the wheeled platform and is moved in the lateral direction. Further, in the case where the ceiling plate is returned to the container body, the ceiling plate is moved toward the container by the wheeled platform, the ceiling plate is supported by the upward movement member from the downside, the wheeled platform is removed from the downside of the ceiling plate, and the ceiling plate is moved downward by the upward movement member so that the ceiling plate closes the container body according to the procedure opposite to the procedure of opening the ceiling plate.

In the ceiling plate opening and closing mechanism, the wheeled platform may include a rolling body.

By this configuration, it is possible to easily move the ceiling plate in the lateral direction.

In the ceiling plate opening and closing mechanism, the ceiling plate may have a line-symmetric shape with respect to a predetermined virtual line, and two support points among three support points may be also located at the line-symmetric positions with respect to the predetermined virtual line.

By this configuration, two points among three support points substantially have the same load.

The ceiling plate opening and closing mechanism may further include a horizontal holding mechanism that synchronizes the upward movement amount of the ceiling plate at the two support points and the other one support point.

By this configuration, since the upward movement amounts are synchronized with one another at two support points and the other one support point other than the two points, there is no need to synchronize with all support points. Thus, it is possible to horizontally move the ceiling plate upward by a compact and simple configuration.

In the ceiling plate opening and closing mechanism, the horizontal holding mechanism may include a plurality of rack gears that is fixed to the ceiling plate and a spur gear that engages with each of the plurality of rack gears and is fixed to one rotatable shaft fixed to the container body, and the inclination of the ceiling plate may be corrected when the spur gear engaging with each of the plurality of rack gears is rotated with the upward movement of the ceiling plate.

By this configuration, it is possible to reliably synchronize the upward movement amounts of the ceiling plate with a simple configuration. Furthermore, it is possible to synchronize the upward movement amounts by providing a pulley in each shaft and connecting the pulleys by a timing belt.

In the ceiling plate opening and closing mechanism, a structure may be placed on the ceiling plate, and the ceiling plate opening and closing mechanism may further include a structure movement support mechanism that supports the movement of the structure with the movement of the ceiling plate.

By this configuration, it is possible to smoothly move the structure placed on the ceiling plate along with the ceiling plate. Furthermore, the structure may be, for example, a column of a semiconductor fabrication device or an inspection device.

In the ceiling plate opening and closing mechanism, an auxiliary device provided in the structure may be connected to the structure, and the ceiling plate opening and closing mechanism may further include an auxiliary device movement mechanism that moves the auxiliary device in synchronization with the movement of the structure.

By this configuration, when the structure moves in the lateral direction along with the ceiling plate, the auxiliary device may be also moved in the lateral direction so as to follow the lateral movement.

In the ceiling plate opening and closing mechanism, the structure and the auxiliary device may be connected to each other by a wire and/or a pipe, the ceiling plate opening and closing mechanism may further include an accommodation box that accommodates the wire and/or the pipe and does not move even when the structure and the auxiliary device move, and the wire and/or the pipe may be accommodated in a flexible cable bearer (Trade Mark).

By this configuration, even when the structure or the auxiliary device moves in the lateral direction, it is possible to smoothly move the structure or the auxiliary device without disturbing the movement thereof by the wire or the pipe connecting them each other.

In the ceiling plate opening and closing mechanism, the wire and/or the pipe may be connected to the structure through a connection accommodation body.

By this configuration, since the wire or the pipe is connected to the structure through the connection accommodation body, it is possible to prevent a problem in which the wire or the pipe is tangled in the vicinity of the connection position with respect to the structure and disturbs the movement of the structure in the lateral direction. Thus, there is no need to cut the wire or the pipe from the structure when the structure is moved in the lateral direction along with the ceiling plate.

In the ceiling plate opening and closing mechanism, a structure may be placed on the ceiling plate, and the ceiling plate opening and closing mechanism may further include a structure movement support mechanism that moves a part of the structure independently from the movement of the ceiling plate.

According to this configuration, it is possible to easily perform the maintenance of the structure placed on the ceiling plate by attaching and separating the ceiling plate.

According to an embodiment of the invention, provided is an inspection device that detects an inspection target, including: a container that includes a container body accommodating the inspection target and a ceiling plate; a column that is provided on the ceiling plate and irradiates the inspection target accommodated in the container with a beam; and a ceiling plate opening and closing mechanism that opens and closes the ceiling plate, wherein the ceiling plate opening and closing mechanism includes an upward movement member that moves the ceiling plate upward while supporting the ceiling plate at three support points from the downside.

By this configuration, since the ceiling plate is moved upward while being supported at three points, the load of the ceiling plate is normally applied to all support points. Accordingly, it is possible to suppress behavior in which the ceiling plate is moved upward in an inclined state and hence to horizontally move the ceiling plate upward.

### BRIEF DESCRIPTION OF DRAWINGS

FIG. 1 is a diagram illustrating an overall configuration of an exemplary device that employs the invention;

FIG. 2 is a diagram illustrating an appearance of an attachment state of a reflecting mirror support mechanism according to an embodiment of the invention;

FIG. 3 is a top view of the reflecting mirror support mechanism of FIG. 2;

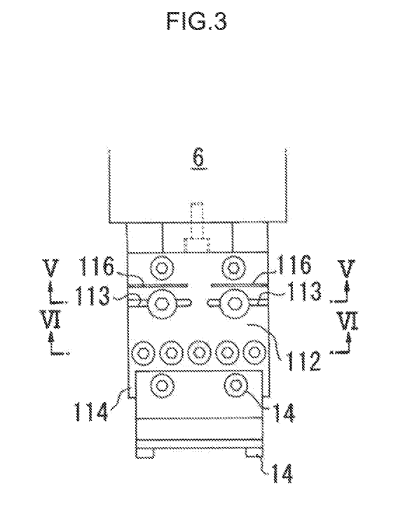

FIG. 4 is a central longitudinal sectional view of the reflecting mirror support mechanism of FIG. 2;

FIG. 5 is a cross-sectional view taken along line V-V of FIG. 2;

FIG. 6 is a cross-sectional view taken along line VI-VI of FIG. 2;

FIG. 7 is a diagram illustrating an overall configuration of an access mechanism used to manipulate the reflecting mirror support mechanism;

FIG. 8 is a diagram illustrating a specific configuration of the access mechanism of FIG. 7;

FIG. 9 is a top view of a reflecting mirror support mechanism and an attachment extension member of another embodiment of the invention;

FIG. 10 is a cross-sectional view taken along line X-X of FIG. 9;

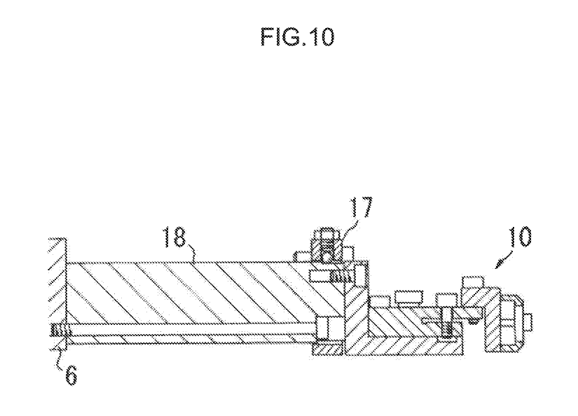

FIG. 11 is a cross-sectional view taken along line XI-XI of FIG. 9;

FIG. 12 is a front view schematically illustrating a main configuration of an inspection device that includes a ceiling plate opening and closing mechanism of the embodiment of the invention;

FIG. 13A is a top view schematically illustrating a main configuration of the ceiling plate opening and closing mechanism of the embodiment of the invention;

FIG. 13B is a front view schematically illustrating a main configuration of the ceiling plate opening and closing mechanism of the embodiment of the invention;

FIG. 14 is a front view illustrating a state where a ceiling plate is moved upward to open the ceiling plate of the embodiment of the invention;

FIG. 15A is a top view illustrating a state where a wheeled platform enters below the upward moved ceiling plate of the embodiment of the invention;

FIG. 15B is a front view illustrating a state where the wheeled platform enters below the upward moved ceiling plate of the embodiment of the invention;

FIG. 16 is a front view illustrating a state where a jack of the embodiment of the invention is shortened so as to place the ceiling plate on the wheeled platform;

FIG. 17A is a top view illustrating a state where the wheeled platform on which the ceiling plate of the embodiment of the invention is placed moves toward a ceiling plate placement table in the lateral direction;

FIG. 17B is a front view illustrating a state where the wheeled platform on which the ceiling plate of the embodiment of the invention is placed moves toward the ceiling plate placement table in the lateral direction;

FIG. 18A is a top view illustrating a state where the ceiling plate of the embodiment of the invention is placed on the ceiling plate placement table;

FIG. 18B is a front view illustrating a state where the ceiling plate of the embodiment of the invention is placed on the ceiling plate placement table;

FIG. 19A is a top view illustrating an example of a configuration for driving the wheeled platform of the embodiment of the invention;

FIG. 19B is a front view illustrating an example of a configuration for driving the wheeled platform of the embodiment of the invention;

FIG. 20A is a top view illustrating another example of a configuration for driving the wheeled platform of the embodiment of the invention;

FIG. 20B is a front view illustrating another example of a configuration for driving the wheeled platform of the embodiment of the invention;

FIG. 21A is a top view illustrating a horizontal holding mechanism of the embodiment of the invention;

FIG. 21B is a view taken along line A-A of FIG. 21A (in a downward movement state);

FIG. 21C is a view taken along line A-A of FIG. 21A (in an upward movement state);

FIG. 22 is a top view schematically illustrating a configuration of a column movement support mechanism of the embodiment of the invention;

FIG. 23 is a front view illustrating the operations of the column movement support mechanism and an auxiliary device movement mechanism of the embodiment of the invention;

FIG. 24 is a front view illustrating a main configuration of an inspection device of a modified example of the embodiment of the invention; and

FIG. 25 is a front view illustrating a main configuration of the inspection device of the modified example of the invention.

### DETAILED DESCRIPTION OF NON-LIMITING EXAMPLE EMBODIMENTS

### First Embodiment

### Reflecting Mirror Posture Adjustment Structure

The embodiment relates to a structure for adjusting the posture of a reflecting mirror set based on a length measurement target of an optical length measurement unit such as a laser interferometer (hereinafter, simply referred to as an “interferometer”). Further, the embodiment relates to a structure that supports a reflecting mirror provided in a narrow place or a vacuum state and is suitable for adjusting the posture thereof.

For example, a drawing device or an inspection device that uses an electron beam includes an electron beam barrel (hereinafter, referred to as a “column”) that generates an electron beam, irradiates a target held on a stage with the electron beam, and treats secondary electrons emitted from the target to analyze the target. Further, the column is disposed above the stage located at a position facing the target.

Here, it is important to highly precisely control the positions of the column and the target when fine drawing treatment is performed on a target or a fine target is inspected. However, the feedback control for the stage based on the measurement of the length of the highly precise laser interferometer is performed on the assumption that the position of the column does not change.

However, the column is provided on the vacuum container and the position of the column actually changes due to the deformation of the container caused by a differential pressure between the vacuum and the atmosphere and a change in environment temperature or atmospheric pressure. Further, the relative position between the column and the stage minutely changes even when the stage is stopped other than the case where the stage is operated due to a disturbance such as a vibration of the stage or a vibration of the external environment or the floor.

As a method of solving such a problem, there is proposed a method in which a reflecting mirror is provided at an end of a column as a so-called “column reference”, the reflecting mirror is irradiated with a laser beam, and the reflected beam is detected as a length measurement value of an interferometer. Thus, the position of the stage is controlled based on the length measurement value. According to this method, the relative displacement of the column and the stage caused by the disturbance such as a change in temperature or a vibration is cancelled in logic, and hence an ideal length measurement system may be constructed (see the manual of “HP2719A” and “HP2721A” manufactured by Agilent Technologies).

However, the reflecting mirror as the reference may not be actually attached to the column due to the limitation in attachment, the above-described disturbance factors increase essentially when the reflecting mirror is attached to the vacuum container near the column. As a result, the original performance and function of the column reference may not be exhibited, and the method and the configuration described above may not be easily implemented.

In the case where the column reference is constructed and is used practically, the following situation and condition may be considered.

As a method of constructing the column reference, the length measurement axis of the stage and the reference axis of the interferometer may be obtained by the combination of several interferometers in theory. However, since there is a limitation in mounting space or cost, it is reasonable to construct the column reference by using one length measurement unit, that is, a multi-axis interferometer with a reference axis and a length measurement axis.

In this case, the posture of the interferometer is first adjusted so that a laser beam emitted from the interferometer is first reflected by the reflecting mirror of the stage body as a length measurement target and is reliably returned to the interferometer. Accordingly, the interferometer is fixed, and hence the adjustment of the length measurement axis is completed.

Next, the reference axis is essentially adjusted just by the adjustment of the posture of the reflecting mirror attached to the column without the operation of the interferometer. However, the following condition needs to be set in order to adjust the reflecting mirror for the reference axis.

First, a configuration is needed in which a mechanism for adjusting the posture of the reflecting mirror does not disturb the column. Specifically, the adjustment mechanism needs to be formed of a non-magnetic material so that the weight is low and the occupying space is small.

Second, there is a need to prevent a change in time of the posture of the reflecting mirror after the adjustment of the adjustment mechanism.

Third, there is a need to adjust the posture of the reflecting mirror in a vacuum state by the manipulation from the atmosphere side when the reflecting mirror is provided in a vacuum state.

The embodiment realizes the reflecting mirror posture adjustment structure capable of constructing the column reference by satisfying the above-described condition necessary for the adjustment of the reflecting mirror for the reference axis. Thus, the highly precise feedback control for the stage based on the highly precise measurement of the length of the interferometer is realized, and hence the precision of the drawing treatment or the inspection for the target held on the stage is improved.

The embodiment will be described with reference to the drawings.

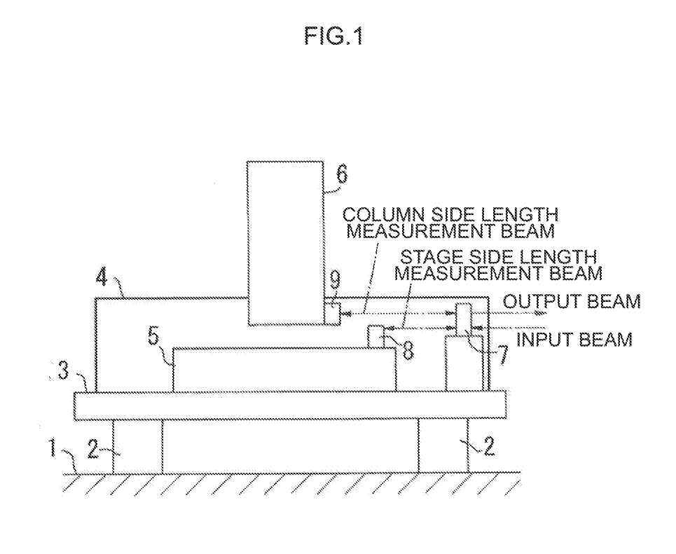

FIG. 1 illustrates an overall configuration of an electron beam application device that employs the reflecting mirror posture adjustment structure of the embodiment. Here, a floor surface 1, an anti-vibration unit 2, a surface plate 3, a vacuum container 4, a stage 5, a column 6, an interferometer 7, and reflecting mirrors 8 and 9 are illustrated in the drawings.

The electron beam application device illustrated in the drawing has a configuration in which the surface plate 3 is supported by the anti-vibration units 2 disposed on the floor surface 1, the vacuum container 4 forming a vacuum environment therein is provided on the surface plate 3, the vacuum container 4 accommodates the stage 5 supporting a target to be irradiated with an electron beam through an electrostatic chuck, and the column 6 of an electron beam optical system or the like is disposed on the upper portion of the vacuum container 4.

The interferometer 7 is disposed inside the vacuum container 4, a laser beam emitted from a laser beam source (not illustrated) disposed at the atmosphere side is caused to incident to the interferometer 7, the laser beam used for the measurement of the length is emitted from the interferometer 7 to the reflecting mirror 8 provided on the stage 5 and the reflecting mirror 9 attached to the lower end of the column 6 by a reflecting mirror holding mechanism 10 to be described later, the laser beams reflected by the reflecting mirrors 8 and 9 are received by the interferometer 7, and the laser beams are output as output beams from the interferometer 7. Then, the relative displacement of the interferometer 7 occurring from the initial state is calculated by an electrical component (not illustrated) disposed at the atmosphere side based on the output beams, and is stored as a signal for the feedback control of the stage 5 in a control system.

By this configuration, a column reference length measurement system based on the lower end of the column 6 is constructed.

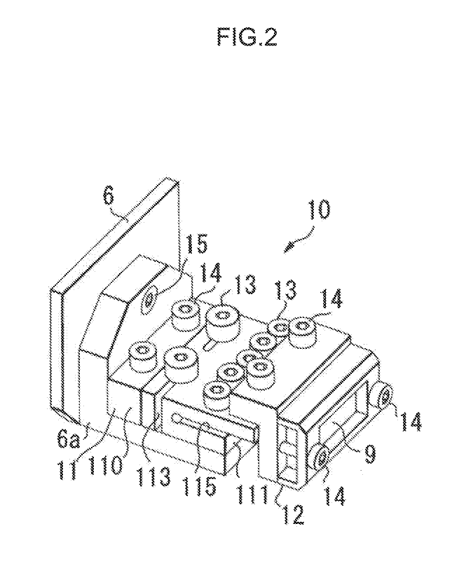

FIG. 2 illustrates an external configuration of the reflecting mirror holding mechanism 10 that supports the reflecting mirror 9 at the lower end of the column 6 in FIG. 1.

As illustrated in the same drawing, the reflecting mirror holding mechanism 10 includes a base 11 which is bent in an L-shape and is disposed on an attachment table 6a fixed to the column 6 by a fixing bolt 15 based on the installation surface of the column 6, a reflecting mirror holder 12 which holds the reflecting mirror 9 and is fixed to the front end of the base 11, and a gap width adjustment member 13 which adjusts the width of the gap of the notched portion formed in the base 11 to be described later.

In the base 11 of the reflecting mirror holding mechanism 10, a fixed portion 110 fixed onto the attachment table 6a and a movable portion 111 including narrow slit-shaped notched portions 113 and 115 are integrally formed in a block shape, and the fixed portion 110 placed on the horizontal attachment surface of the attachment table 6a is fixed to the attachment table 6a by fixing bolts 14 and 14. Further, movable displacement absorbing slits 116 and 116 are formed at both sides of the boundary between the fixed portion 110 and the movable portion 111.

The movable portion 111 is continuous to the fixed portion 110, and includes a first movable portion 112 provided with a pair of notched portions 113 and 113 which is notched at both left and right sides in a direction perpendicular to the lower surface of the fixed portion 110 and a second movable portion 114 being continuous to the front end side of the first movable portion 112 and provided with a notched portion 115 which is notched from the front end side toward the root side in a direction parallel to the lower surface of the fixed portion 110. Here, the reflecting mirror holder 12 is integrally fixed to the front end of the movable portion 114 by the fixing bolts 14 and 14.

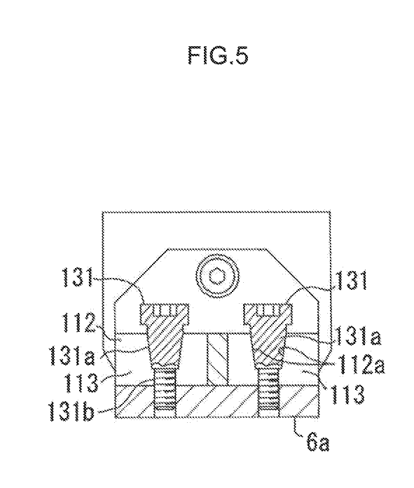

As illustrated in FIG. 5, in the first movable portion 112, a pair of female tapered portions 112a and 112a which is depressed downward is formed in the facing surfaces of each of the pair of notched portions 113 and 113. Here, a bolt type gap width adjustment member 131 of which the outer peripheral surface is provided with a male tapered portion 131a to be combined with the female tapered portions 112a and 112a is fitted into the female tapered portions 112a and 112a from the upside thereof, and a screw portion 131b which is provided in the front end of the gap width adjustment member 131 is fixed while being threaded into a screw hole provided in the attachment table 6a overlapping the lower side of the first movable portion 112.

Then, when the threading depth of the screw portion 131b of each of the gap width adjustment members 131 and 131 is changed, the gap width of each of the notched portions 113 and 113 of the first movable portion 112 decreases or increases. Thus, the inclining degree of the reflecting mirror 9 which is held by the reflecting mirror holder 12 is adjusted in the lateral direction.

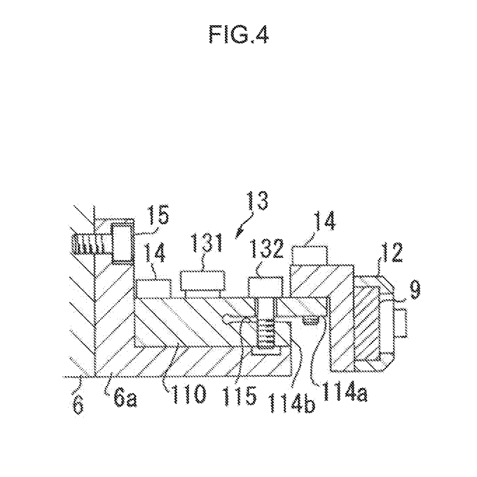

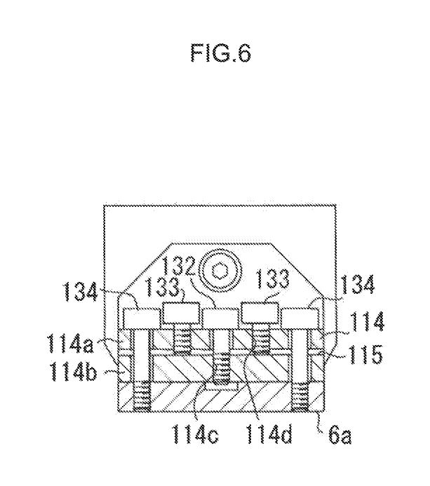

Further, as illustrated in FIGS. 4 and 6, the second movable portion 114 is formed by an upper movable piece 114a and a lower movable piece 114b facing the notched portion 115. Here, a gap width adjustment member 13 which is disposed on the upper surface of the upper movable piece 114a includes a pulling bolt 132 of which the shaft portion is threaded into a screw hole 114c provided in the lower movable piece 114b while penetrating the upper movable piece 114a, pushing bolts 133 and 133 of which the shaft portions are threaded into screw holes 114d provided in the upper movable piece 114a and the ends of the shaft portions are bonded to the upper surface of the lower movable piece 114b, and fixing bolts 134 of which shaft portions 134a penetrate the upper movable piece 114a and the lower movable piece 114b near both sides of the pushing bolts 133 and 133 and are threaded into the attachment table 6a overlapping the lower side of the second movable portion 114 to fix the second movable portion 114.

Then, when the threading depth of the pulling bolt 132 of the gap width adjustment member 13 with respect to the lower movable piece 114b and the threading depth of each of the pushing bolts 133 and 133 with respect to the upper movable piece 114a are changed, the gap width of the notched portion 115 of the second movable portion 114 decreases or increases. Thus, the inclining degree of the reflecting mirror 9 which is held by the reflecting mirror holder 12 is adjusted in the lateral direction.

Furthermore, each of the top surfaces of the members 131 to 134 of the gap width adjustment member 13 is provided with a concave portion into which a lower end of a manipulation bar 161 of an access mechanism 16 is fitted. Further, these members that constitute the reflecting mirror holding mechanism 10 are formed of a non-magnetic material.

As for the adjustment of the posture of the reflecting mirror 9 by the reflecting mirror holding mechanism 10, the widths of the notched portions 113 and 113 of the first movable portion 112 are first adjusted by the manipulation of the gap width adjustment members 131 and 131 so as to adjust the inclining degree of the reflecting mirror 9 in the lateral direction. Subsequently, the width of the notched portion 115 of the second movable portion 114 is adjusted by the manipulation of the gap width adjustment members 132, 133, and 133 so as to adjust the inclining degree of the reflecting mirror 9 in the longitudinal direction. Then, the shaft portions of the fixing bolts 134 and 134 are threaded into the attachment table 6a so as to fix the base 11 to the attachment table 6a. In this way, the posture of the reflecting mirror 9 is adjusted.

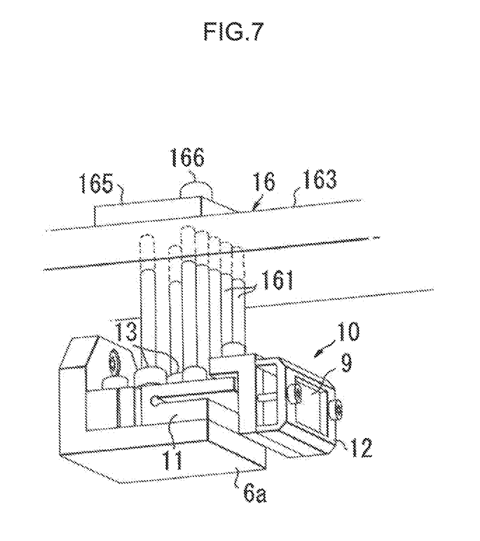

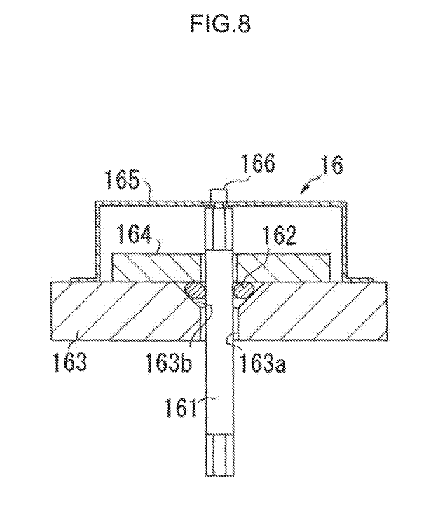

FIGS. 7 and 8 illustrate a configuration of the access mechanism 16 in which the gap width adjustment member 13 of the reflecting mirror holding mechanism 10 may be manipulated in a vacuum state when the reflecting mirror holding mechanism 10 is disposed in a vacuum state.

As illustrated in both drawings, the access mechanism 16 includes a manipulation bar 161 of which both ends are cut into six faces so that the manipulation bar may be manipulated from the atmosphere side above the reflecting mirror holding mechanism 10 and a sealing mechanism 162 such as an O-ring which seals the outer peripheral surface of the manipulation bar 161.

Specifically, as illustrated in FIG. 8, a sealing base plate 163 which seals the upper space is provided above the reflecting mirror holding mechanism 10, the manipulation bar 161 is inserted through a hole portion 163a provided in the sealing base plate 163 and a tapered portion 163b forming a part of a triangular groove at the upper portion thereof, and an O-ring as the sealing mechanism 162 is disposed on the outer peripheral portion of the manipulation bar 161, so that a vacuum seal is formed inside the triangular groove.

The upper surface of the sealing base plate 163 through which the manipulation bar 161 is inserted is provided with a cover plate 164 formed as an O-ring seal so that the gap is blocked. Further, a stopper cover 165 which serves to restrict the downward displacement of the manipulation bar 161 after the adjustment covers the upside thereof. Here, a stopper mechanism is formed by the stopper cover 165 and a stopper bolt 166 which protrudes from the upper surface of the stopper cover 165 and is connected to the upper end of the manipulation bar 161, and hence a displacement caused by the differential pressure between the atmosphere and the vacuum may be suppressed.

In the access mechanism 16, the lower end of the manipulation bar 161 is fitted to the opening of the top surface of the gap width adjustment member 13 of the reflecting mirror holding mechanism 10 disposed in a vacuum state from the upside thereof, and the manipulation bar 161 is rotated at the atmosphere side to transmit a torque to the gap width adjustment member 13 so that the widths of the notched portions 113 and 113, 115 formed in the base 11 of the reflecting mirror holding mechanism 10 are adjusted. Also, the shaft portions of the fixing bolts 134 and 134 are threaded into the attachment table 6a so that the base 11 is fixed to the attachment table 6a.

In the case where the reflecting mirror holding mechanism 10 with the above-described configuration is attached to the column 6, there is a case where the reflecting mirror holding mechanism 10 needs to be provided outside of the column 6 so as to be slightly separated from the column 6 due to the limitation in design of the vacuum container 4 or the column 6. In that case, since the reflecting mirror holding mechanism 10 is attached to the column 6 in a so-called cantilever state, there is a possibility that a vibration or a displacement as noise may occur.

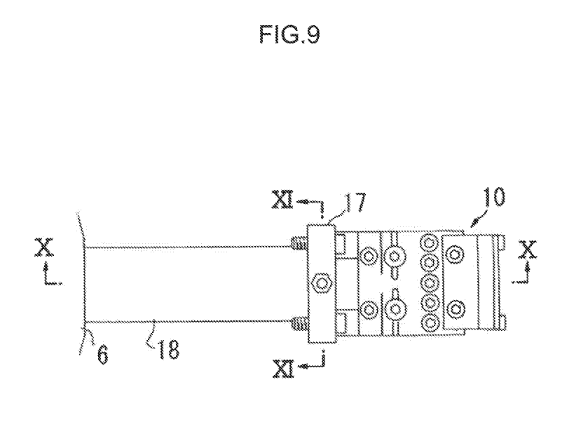

As the countermeasure for such a case, it is desirable to employ a configuration in which an annular extension holding member 17 is provided near the vacuum container 4 and a column extension attachment member 18 is disposed so as to penetrate a hole portion 17a provided in the member as illustrated in FIG. 9.

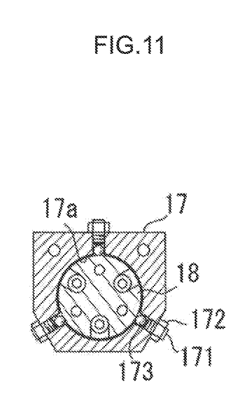

Specifically, as illustrated in FIG. 11, the extension holding member 17 is formed to support the column extension attachment member 18 while serving as a free support portion that corresponds to a ball rolling body and supports the peripheral surface of the column extension attachment member 18 through a pushing bolt 171, a locking nut 172, and a spherical body 173 at three sides in the circumferential direction. Thus, the degree of freedom of the column 6 in the length measurement direction is widely ensured by solving the cantilevered state.

Furthermore, it is desirable that the column extension attachment member 18 be formed of a material such as ceramics having a low linear expansion coefficient.

Furthermore, a case has been described in which the reflecting mirror 9 is applied to the device provided in a vacuum state in the embodiment illustrated in the drawings, but the embodiment may be also applied to a case where the reflecting mirror is provided in an atmosphere state.

Further, the structure of the reflecting mirror holding mechanism 10 or the access mechanism 16 is an example, and the embodiment is not limited thereto. For example, the reflecting mirror holding mechanism 10 or the access mechanism 16 may be formed in the other appropriate structure.

### Second Embodiment

### Ceiling Plate Opening and Closing Mechanism and Inspection Device

As described above, as the container used to accommodate the stage in the semiconductor inspection device, there is known a container that opens the entire ceiling plate (the upper plate) (as a ceiling plate opening operation) so that the stage may be accessed as much as possible. However, in a container of which a side surface is provided with an opening/closing door or a container of which a part is provided with an opening and in which the opening is covered by a lid in a normal state and the lid is removed only at the necessary time, the stage access range is limited to the opening provided with the door or the lid, and hence the workability or the efficiency for the repair or the maintenance is degraded. Further, the stability of the operation is degraded, and hence the reliability of the device is also degraded. Meanwhile, even in the structure in which the stage is accessed by opening the entire ceiling plate of the container (the ceiling plate opening operation), the following problem arises.

The size of the container is various in accordance with the treatment or inspection target or the size of the stage used for the target, but the container may be a cube of about 1 m by 1 m in many cases. Further, since the inside of the container is maintained a vacuum state, the container needs rigidity capable of withstanding the differential pressure with respect to the atmosphere outside the container, and hence the container is inevitably thickened. Further, there is a case where the load may be 1 ton or more by the sum of the ceiling plate and the column in a place where the column as the device used for the treatment or the inspection is disposed on the ceiling plate.

For that reason, in the structure in which the stage is accessed as much as possible by opening the entire ceiling plate of the container (the ceiling plate opening operation) it is not easy to open the ceiling plate. As a result, much time or effort is necessary for the repair or the maintenance, and the down time (the non-operation time) of the device increases.

Meanwhile, in the case where the entire ceiling plate of the container is opened, the ceiling plate may be opened in a manner such that the ceiling plate is moved upward and is moved laterally. However, at this time, as described above, the upward movement member is formed so that four upward movement support points are set in the ceiling plate. Due to this configuration, in order to horizontally maintain the posture of the ceiling plate, a synchronization mechanism is generally needed so that the upward movement amount at four points is maintained. For this reason, there is a need to provide a space for setting four upward movement support points and a space for the synchronization mechanism. Thus, the area around the container is occupied, and hence the design for another device is limited. Further, in the case where the synchronization mechanism is not used, there is a need to manipulate each upward movement amount while checking the upward movement amount of each of the upward movement support points. Thus, the manipulation is troublesome, and hence a problem in safety also arises.

The embodiment is contrived to solve the above-described problems, and an object thereof is to provide a ceiling plate opening and closing mechanism capable of horizontally moving a ceiling plate upward.

Hereinafter, the ceiling plate opening and closing mechanism of the embodiment will be described with reference to the drawings. Furthermore, the embodiment to be described below is an example, and the invention is not limited to the specific configuration below. In the embodiment of the invention, a specific configuration may be appropriately employed in response to the embodiment. Hereinafter, an example will be described in which the ceiling plate opening and closing mechanism of the embodiment is used in a vacuum container that accommodates a stage of an inspection device. However, the ceiling plate opening and closing mechanism of the embodiment may be also applied as a mechanism that opens and closes a ceiling plate of a vacuum container of another device such as a semiconductor fabrication device.

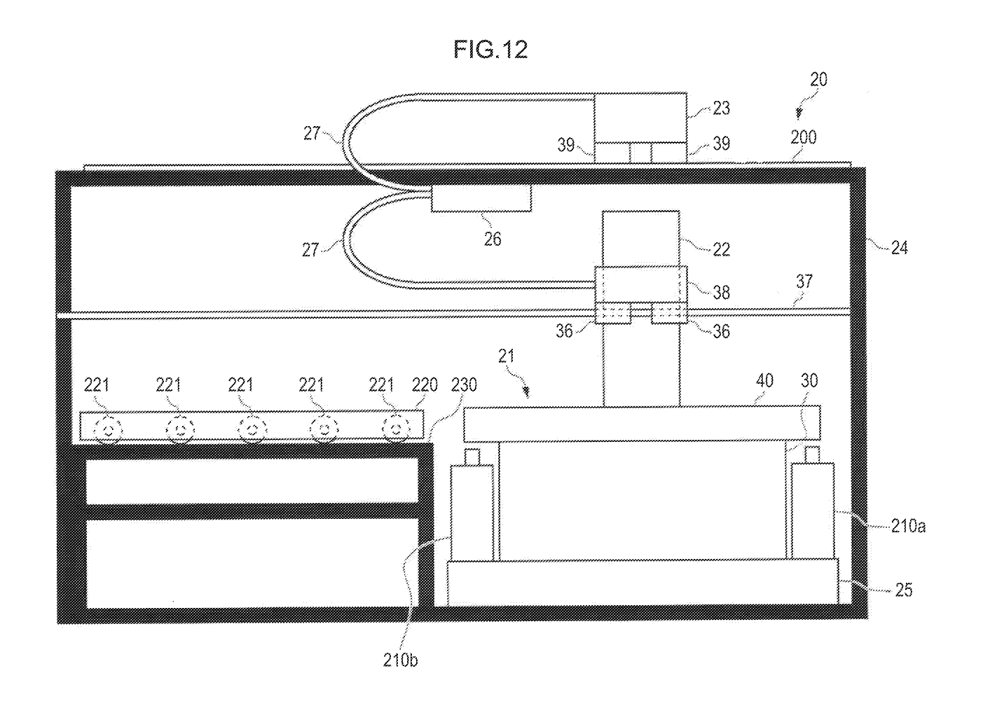

FIG. 12 is a front view schematically illustrating a main configuration of an inspection device including the ceiling plate opening and closing mechanism of the embodiment. An inspection device 100 includes a vacuum container (hereinafter, simply referred to as a “container”) 21, a column 22, an auxiliary device 23, a housing 24, a surface plate 25, and a ceiling plate opening and closing mechanism. The container 21, the column 22, and the surface plate 25 are provided inside the housing 24. Furthermore, in the description below for the inspection device 100, the left and right direction of FIG. 12 is set as the left and right direction, the lateral direction, or the horizontal direction, the up and down direction of FIG. 12 is set as the up and down direction, the longitudinal direction, or the vertical direction, and the direction perpendicular to the drawing paper of FIG. 12 is set as the depth direction (the direction which is opposite to or close to the viewer).

The container 21 schematically has a rectangular parallelepiped shape, and includes a bottom surface plate, a right surface plate, a left surface plate, a front surface plate, a rear surface plate, and a top plate, that is, a ceiling plate. The bottom surface plate, the right surface plate, the left surface plate, the front surface plate, and the rear surface plate are integrally formed with one another (hereinafter, referred to as a “container body 30”), and a ceiling plate 40 is separable from the container body 30. A stage (not illustrated) used to place a sample thereon is disposed inside the container 21.

The column 22 substantially has a cylindrical shape. The column 22 is provided on the ceiling plate 40 of the container 21. The column 22 forms a beam to be emitted to the sample inside the container 21. The ceiling plate 40 of the container 21 is formed so that a concave portion is substantially formed at the center position thereof so as to place the column 22 thereon. The concave portion is formed so that the beam formed by the column 22 is transmitted therethrough. The beam which is formed by the column 22 is emitted to the sample placed on the stage inside the container 21 through the concave portion. Further, the beam which is reflected by the sample is also incident to the column 22 through the concave portion of the ceiling plate 40. Furthermore, the column 22 corresponds to a structure.

The container 21 is provided on the surface plate 25 having high rigidity. The surface plate 25 is provided on an anti-vibration unit (not illustrated). The column 22 and the auxiliary device 23 are connected to each other by a wire and a pipe through an accommodation box 26 fixed to the housing 24. The wire and the pipe are accommodated in a flexible cable bearer 27.

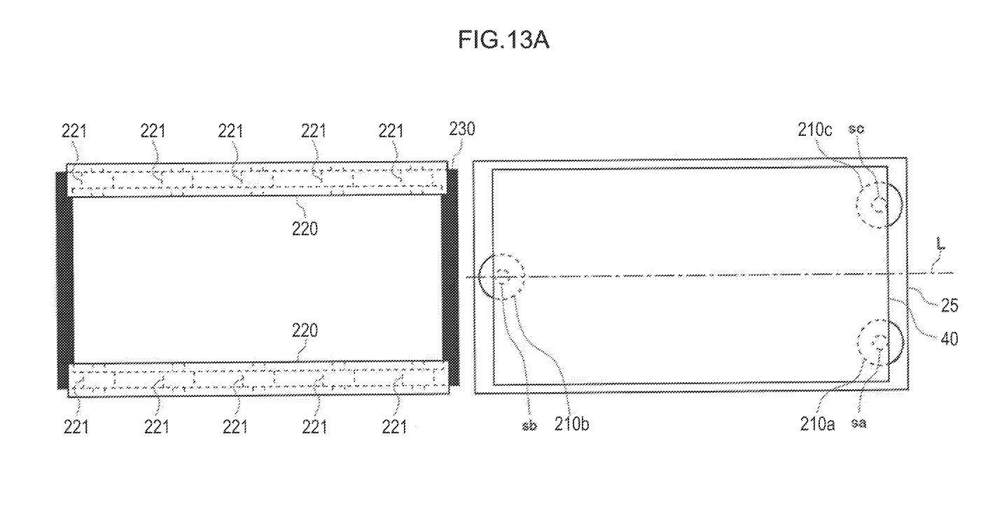

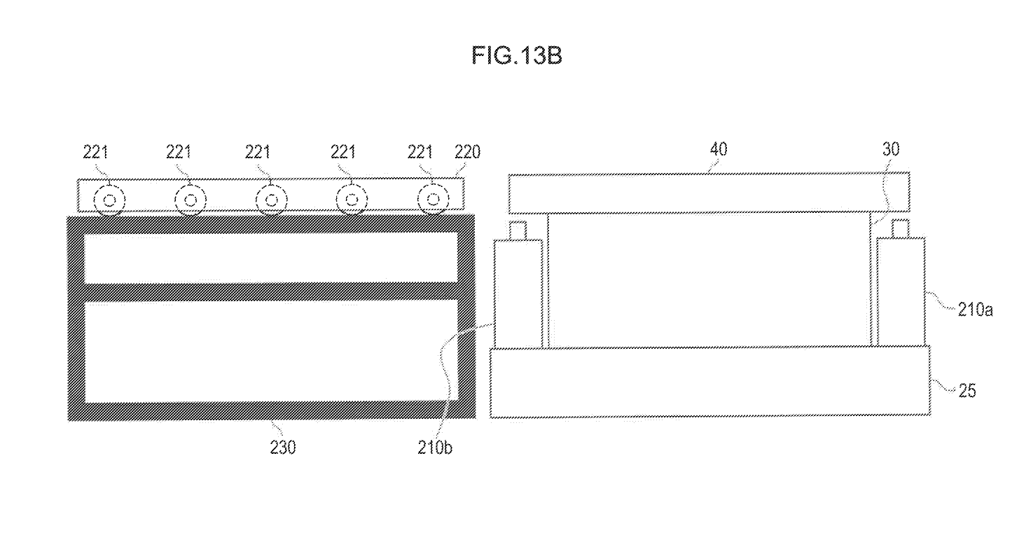

The ceiling plate opening and closing mechanism which opens and closes the ceiling plate 40 of the container 21 is provided inside the housing 24. FIGS. 13A and 13B are top and front views schematically illustrating a main configuration of the ceiling plate opening and closing mechanism of the embodiment. Hereinafter, the ceiling plate opening and closing mechanism will be described with reference to FIGS. 13A and 13B along with FIG. 12. The inspection device 100 includes three jacks 210a to 210c, a wheeled platform 220, and a ceiling plate placement table 230 as the ceiling plate opening and closing mechanism.

The jacks 210a to 210c are hydraulic jacks. The jacks 210a to 210c are provided below the ceiling plate 40 so as to move three support points in the vicinity of the outer peripheral portion of the ceiling plate 40 of the container 21 upward from the downside while supporting the three support points. Three jacks 210a to 210c are driven by the same driving source (hydraulic source). Furthermore, the jacks 210a to 210c correspond to the upward movement members.

The ceiling plate 40 has a rectangular shape in the top view, and has a line-symmetric shape with respect to the virtual line L passing through the center of the ceiling plate. Thus, the load of the ceiling plate 40 which is applied downward due to the gravity is also line-symmetric with respect to the virtual line L. The support points sa, sb, and sc where the jacks 210a to 210c support the ceiling plate 40 are respectively set in the vicinity of the outer peripheral portion of the ceiling plate 40, but two jacks 210a and 210c among three jacks 210a to 210c are provided so that the support points sa and sc are located at the positions which are line-symmetric with respect to the virtual line L. Thus, the load values applied to the support points sa and sc of the jack 210a and 210c become equal to each other. Accordingly, the ceiling plate 40 may be supported horizontally by setting the load values applied to the support points sa and sc to be equal to the load value applied to the support point sb of the jack 210b.

The wheeled platform 220 is provided at two positions corresponding to the positions before and behind the container 21. The wheeled platform 220 includes a plurality of rolling bodies (rolls) 221, and is movable between the ceiling plate placement table 230 and the container 21 in the lateral direction. The surface that supports the wheeled platform 220 in the ceiling plate placement table 230 is set to the height substantially equal to the height of the upper surface of the container body 30. Furthermore, the ceiling plate placement table 230 is provided near the container 21. However, since the container 21 is provided in the surface plate 25 fixed to the anti-vibration units so that the container is free from the vibration, the ceiling plate placement table 230 is separated from the container 21 so that a vibration is not transmitted to the container 21. The wheeled platform 220 and the ceiling plate placement table 230 correspond to the lateral movement mechanisms.

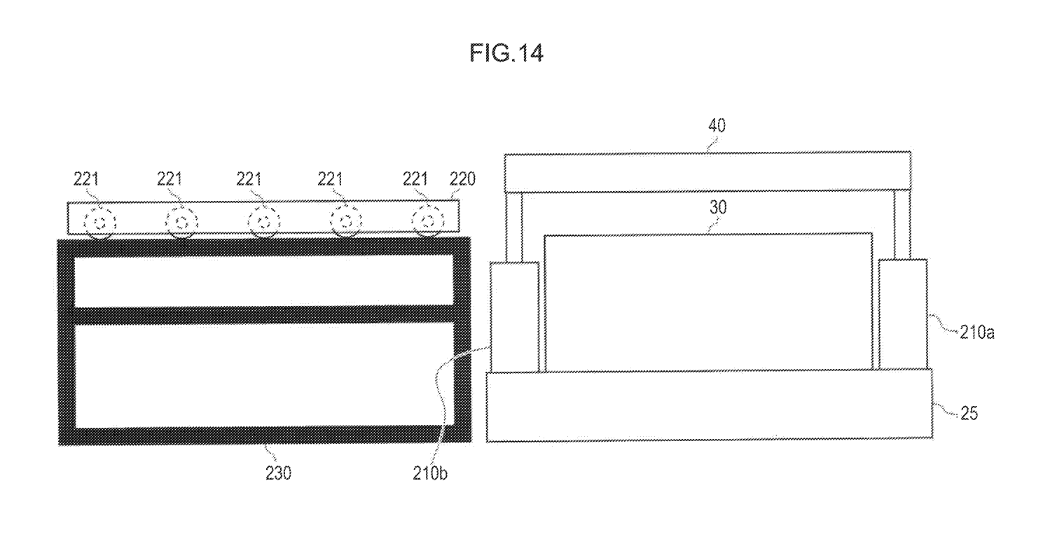

The operation of the ceiling plate opening and closing mechanism with the above-described configuration will be described with reference to FIGS. 14 to 18B. FIG. 14 is a front view illustrating a state where the ceiling plate 40 is moved upward to open the ceiling plate. When the jacks 210a to 210c are lengthened while supporting the ceiling plate 40 at the support points sa to sc from the downside, the ceiling plate 40 moves upward while being lifted by the jacks 210a to 210c as illustrated in FIG. 14. At this time, the jacks 210a to 210c move the ceiling plate 40 to a sufficient height so that the wheeled platform 220 is inserted below the ceiling plate 40.

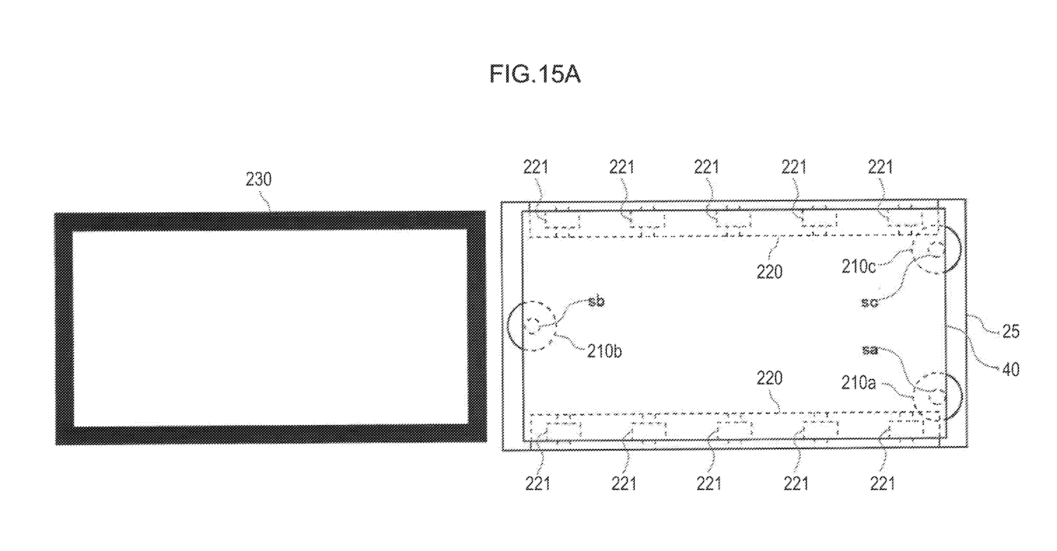

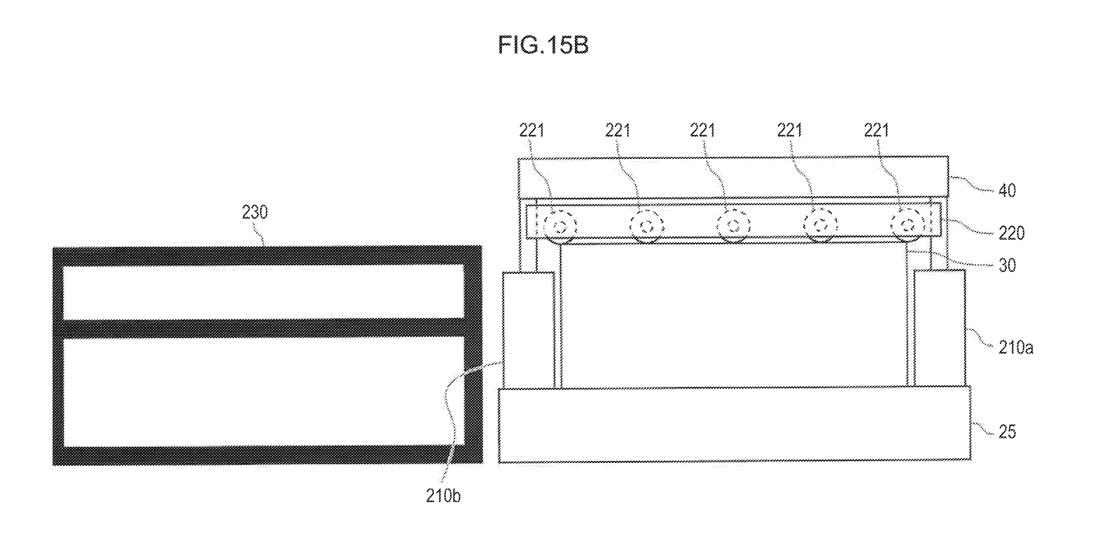

FIGS. 15A and 15B are top and front views illustrating a state where the wheeled platform 220 enters below the ceiling plate 40 that is moved upward. As illustrated in FIG. 14, when the ceiling plate 40 sufficiently moves upward, the rolling bodies 221 rotate so as to move the wheeled platforms 220 toward the container 21 in the lateral direction, and hence the wheeled platforms 220 move to the lower side of the ceiling plate 40. In this movement, the front wheeled platform 220 and the rear wheeled platform 220 move while the rolling bodies 221 roll on the front surface plates and the rear surface plates of the container body 30. When each wheeled platform 220 moves to a position just below the ceiling plate 40, the wheeled platform stops at that position.

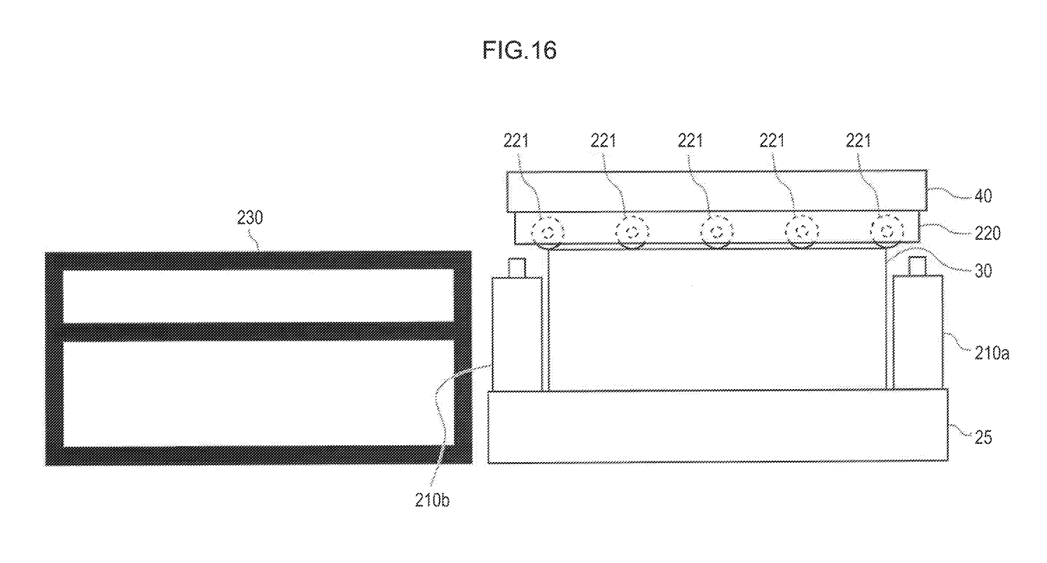

FIG. 16 is a front view illustrating a state where the jacks 210a to 210c are shortened so as to place the ceiling plate 40 on the wheeled platform 220. When the jacks 210a to 210c are shortened, the ceiling plate 40 also moves downward, and is supported by the wheeled platform 220. Even after the ceiling plate 40 is supported by the wheeled platform 220, the jacks 210a to 210 are further shortened to the original positions. In this state, the ceiling plate 40 is supported by two wheeled platforms 220 at the position in the vicinity of the front outer peripheral portion and the position in the vicinity of the rear outer peripheral portion, and two wheeled platforms 220 are respectively supported by the front and rear surface plates of the container body 30.

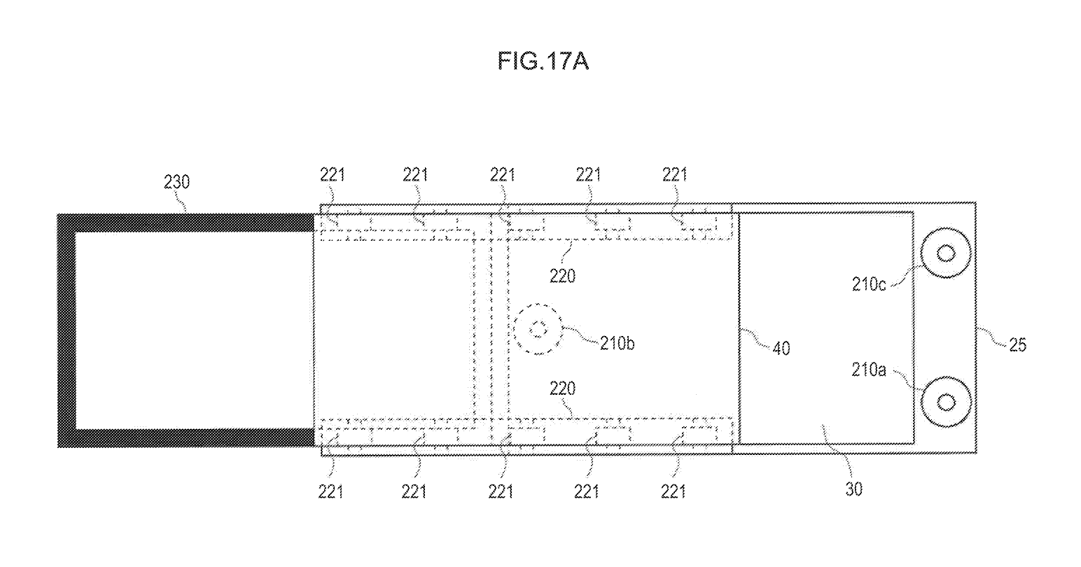

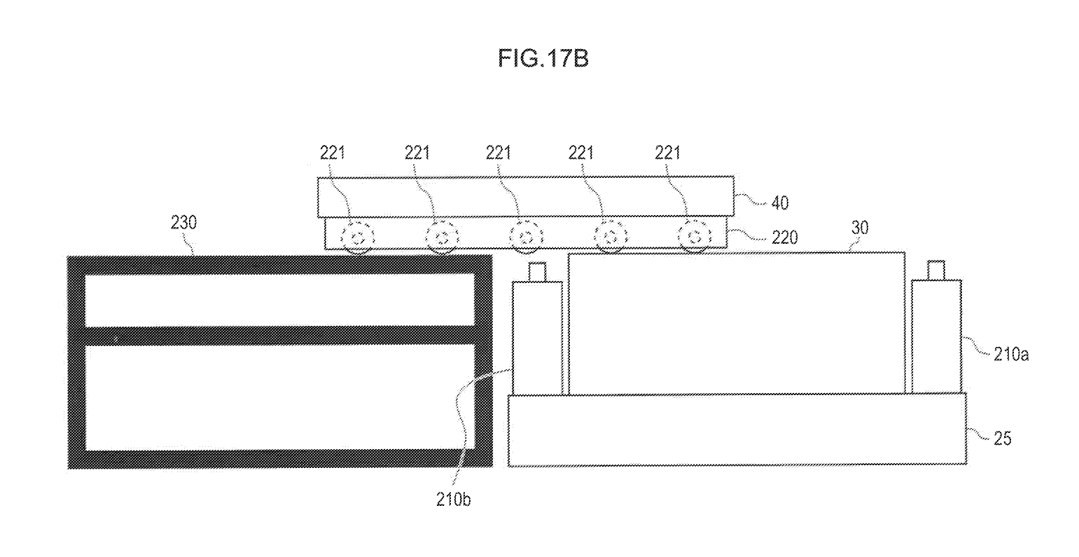

FIGS. 17A and 17B are top and front views illustrating a state where the wheeled platform 220 having the ceiling plate 40 placed thereon moves toward the ceiling plate placement table 230 in the lateral direction. The wheeled platform 220 having the ceiling plate 40 placed thereon moves toward the ceiling plate placement table 230 while rotating the rolling bodies 221. As described above, since the height of the surface that supports the wheeled platform 220 in the ceiling plate placement table 230 matches the height of the upper surface of the container body 30, the wheeled platform 220 may smoothly move from the upper surface (the upper surfaces of the front and rear surface plates) of the container body 30 to the wheeled platform support surface of the ceiling plate placement table 230.

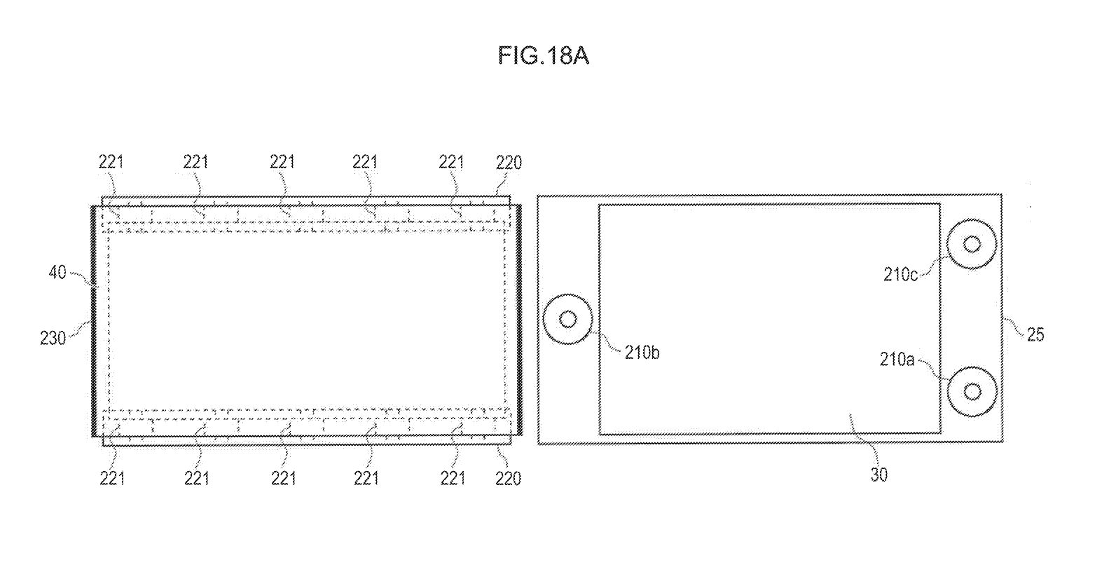

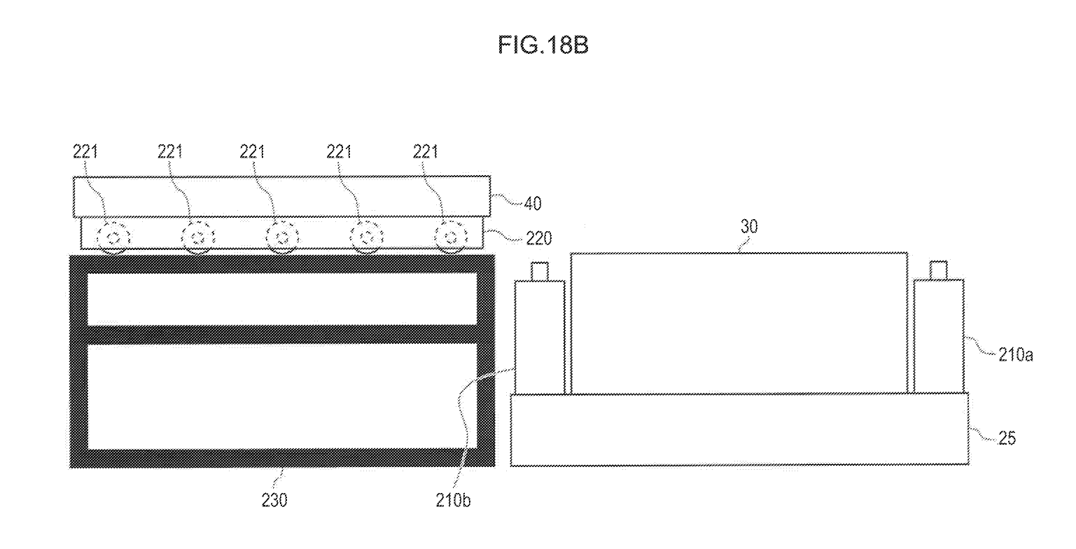

FIGS. 18A and 18B are top and front views illustrating a state where the ceiling plate 40 is placed on the ceiling plate placement table 230. When the wheeled platform 220 moves in the lateral direction so that the wheeled platform completely moves from the container body 30 to the ceiling plate placement table 230, the upper surface of the container body 30 is completely opened, and hence a worker may access the container body 30 from the upper surface thereof in order to conduct a repair or a maintenance. Further, the ceiling plate 40 which is removed from the container body 30 is stably held by the ceiling plate placement table 230 while being placed on the wheeled platform 220.

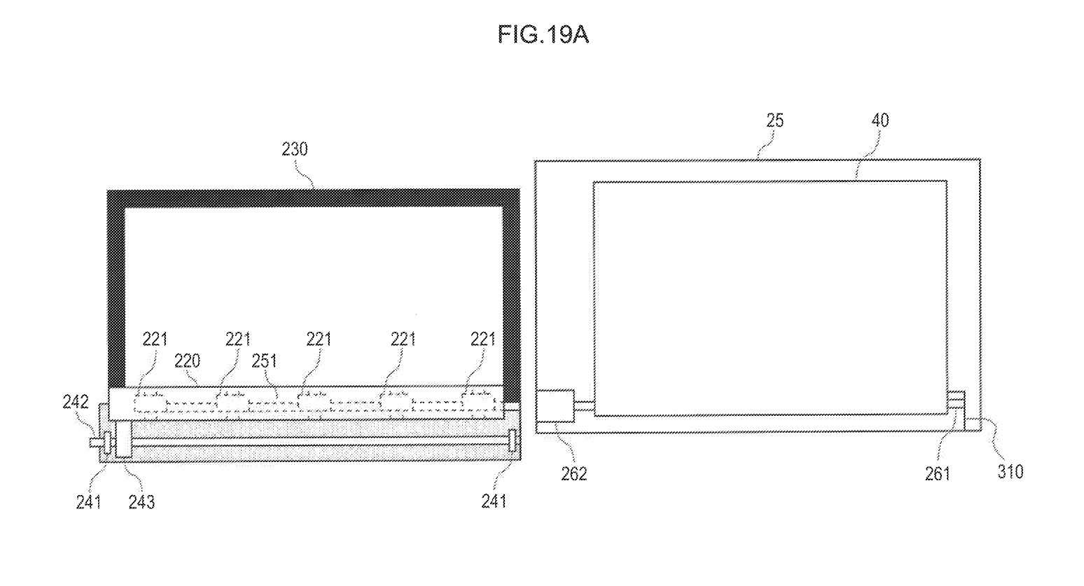

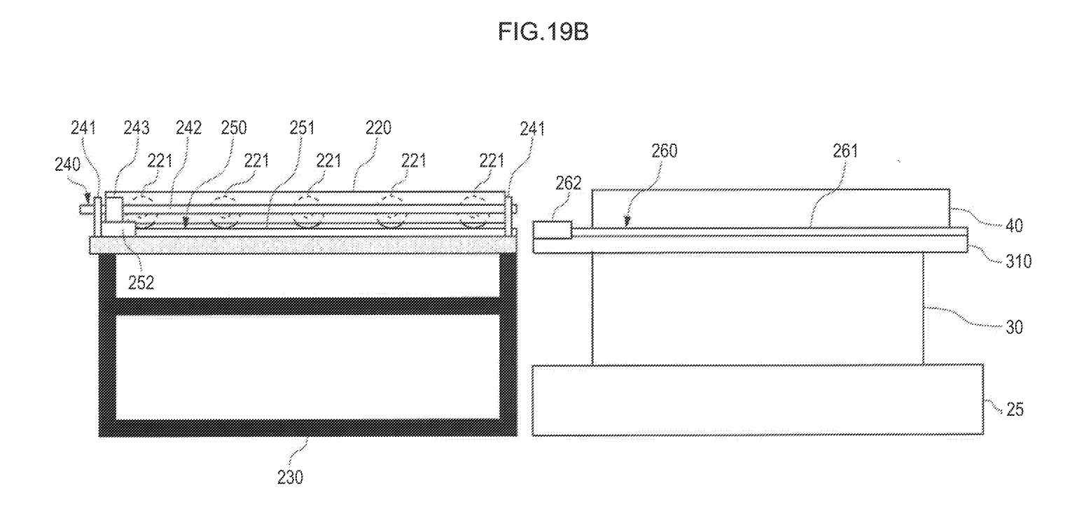

Next, a configuration for driving the wheeled platform 220 will be described. FIGS. 19A and 19B are top and front views illustrating an example of a configuration for driving the wheeled platform 220. The lateral movement mechanism includes a ball screw 240 and linear guides 250 and 260 as a configuration for driving the wheeled platform 220. The ball screw 240 is provided on the ceiling plate placement table 230. The linear guide 250 is provided in the ceiling plate placement table 230, and the linear guide 260 is provided in the container 21.

The linear guide 250 includes a linear guide rail 251 which is fixed to the ceiling plate placement table 230 and a linear guide block 252 which slides on the linear guide rail 251. The linear guide rail 251 extends in the movement direction (the direction from the ceiling plate placement table 230 toward the container 21) of the wheeled platform 220 in parallel to the wheeled platform 220. The linear guide block 252 may be connected to the rear end of the wheeled platform 220 in a direction toward the container 21. When the rear end of the wheeled platform 220 is connected to the linear guide block 252, the linear guide 250 restricts (guides) the movement of the wheeled platform 220 so that the rear end of the wheeled platform 220 moves along the linear guide rail 251.

The linear guide 260 includes a linear guide rail 261 which is fixed to a linear guide receiving portion 310 protruding forward in the vicinity of the upper end of the front surface plate of the container body 30 and a linear guide block 262 which slides on the linear guide rail 261. The linear guide rail 261 extends in the movement direction (the direction from the ceiling plate placement table 230 toward the container 21) of the wheeled platform 220 in parallel to the wheeled platform 220. The linear guide rail 261 is provided so as to be located on the same line along with the linear guide rail 251. The linear guide block 262 may be connected to the front end of the wheeled platform 220 in a direction toward the container 21. When the wheeled platform 220 moves from the ceiling plate placement table 230 toward the container body 30, the linear guide block 262 is connected to the front end of the wheeled platform 220, and restricts (guides) the movement of the wheeled platform 220 so that the front end of the wheeled platform 220 moves along the linear guide rail 261. Furthermore, when the wheeled platform 220 moves toward the ceiling plate placement table 230, the front end of the wheeled platform 220 is separated from the guide block 262, and hence the wheeled platform 220 gets on only the ceiling plate placement table 230.

The ball screw 240 includes a ball screw bearing 241 which is fixed to the ceiling plate placement table 230, a ball screw shaft 242 which is rotatably supported by the ball screw bearing 241, and a ball screw nut 243 which may be connected to the side surface of the rear end of the wheeled platform 220. The ball screw shaft 242 is connected to a rotational power source such as a motor (not illustrated), and is rotationally driven. When the ball screw shaft 242 rotates, the ball screw nut 243 moves on the ball screw shaft 242, and hence the wheeled platform 220 connected to the ball screw nut 243 is driven.

The lateral movement mechanism is formed so that a position where the ball screw nut 243 reaches the ball screw bearing 241 at the side of the container 21 becomes a position the ceiling plate 40 of the container 21 is closed (a position where the container 21 entirely overlaps the ceiling plate 40). Here, in the case where the ceiling plate 40 is opened or closed, the wheeled platform 220 and the ball screw nut 243 are connected to or separated from each other at the position. That is, when the ceiling plate 40 is moved from the opened position to the closed position, the ceiling plate 40 is moved upward by three jacks 210a to 210c, the wheeled platform 220 and the ball screw nut 243 are separated from each other, the wheeled platform 220 is extracted from the lower side of the ceiling plate 40, and the wheeled platform 220 is moved toward the ceiling plate placement table 230. In the case where the ceiling plate 40 is opened, the ceiling plate 40 is moved upward by three jacks 210a to 210c, the wheeled platform 220 is inserted below the ceiling plate 40, three jacks 210a to 210c are shortened to place the ceiling plate 40 onto the wheeled platform 220, the wheeled platform 220 is connected to the ball screw nut 243, and the wheeled platform 220 is moved toward the ceiling plate placement table 230.

According to the lateral movement mechanism of this example, the wheeled platform 220 may accurately move along a desired path by the linear guides 250 and 260. Further, particularly when the ceiling plate 40 as a heavy object is placed on the wheeled platform 220 above the container body 30 and the wheeled platform 220 is moved toward the ceiling plate placement table 230, the wheeled platform 220 may be driven by the power of the rotational power source.

Furthermore, FIGS. 19A and 19B illustrate an example in which only the front surface side is provided with the ball screw 240 and the linear guides 250 and 260, but the rear surface side may be provided with these members in the same configuration. In this case, when the ball screw shaft at the front surface side and the ball screw shaft at the rear surface side are respectively provided with pulleys and the pulleys are connected to each other by a belt, the ball screws may by synchronized with each other by both ball screw shafts rotatably connected to each other.

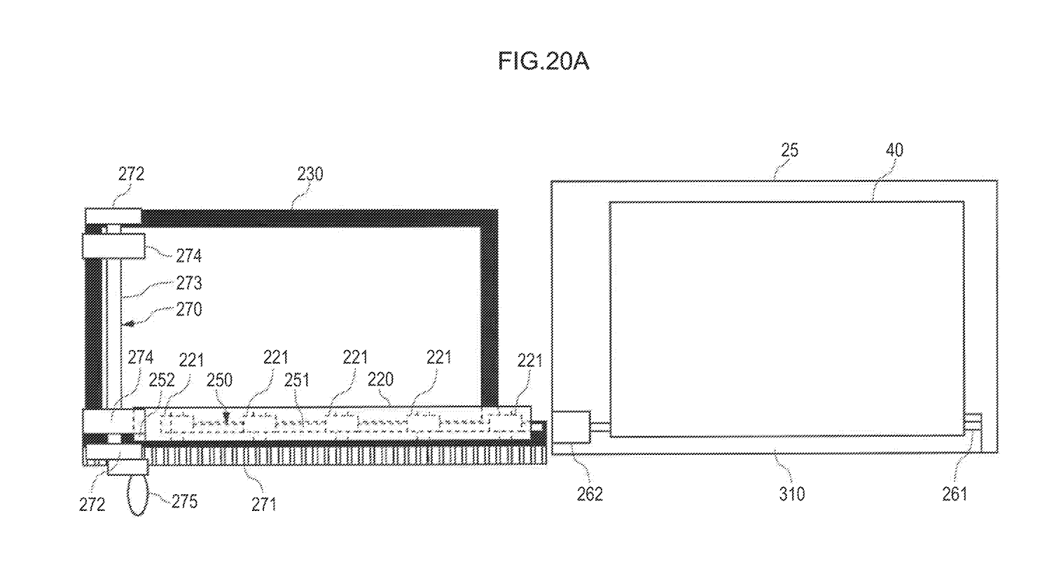

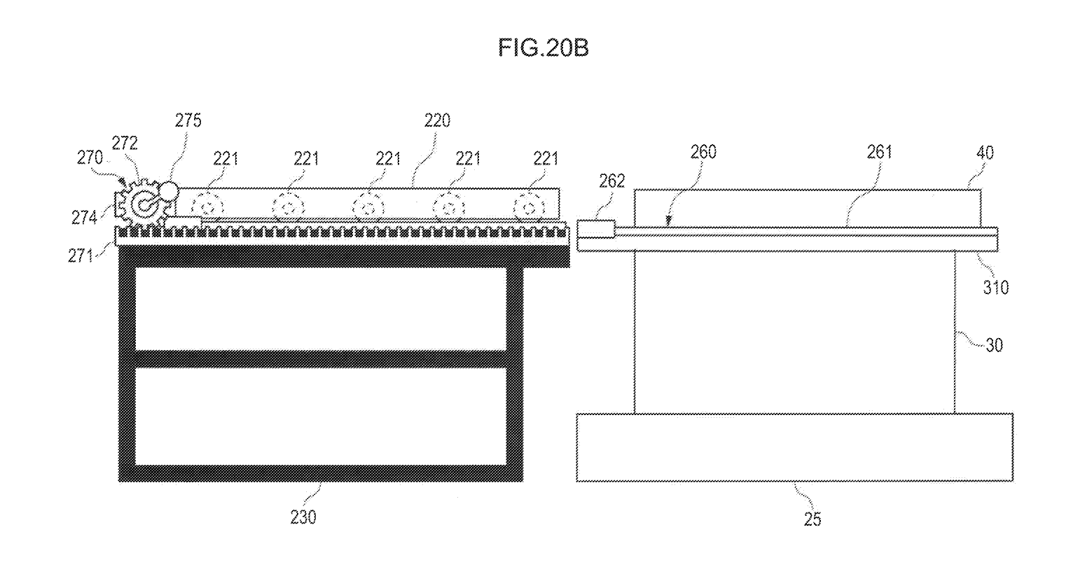

FIGS. 20A and 20B are top and front views illustrating another example of a configuration for driving the wheeled platform 220. In this example, the ceiling plate opening and closing mechanism includes the linear guide 250 and the linear guide 260 described in FIGS. 19A and 19B as the lateral movement mechanism, and includes a rack and pinion 270 instead of the ball screw 240 of the example of FIGS. 19A and 19B. The rack and pinion 270 is provided on the ceiling plate placement table 230.

The rack and pinion 270 includes a rack gear 271 which is fixed to the ceiling plate placement table 230 so that the gear surface is directed upward, a spur gear (gear) 272 which engages with the rack gear 271, a shaft 273 which is fixed to the center of the spur gear 272, a shaft holder 274 which rotatably holds the shaft 273 and is connectable to the wheeled platform 220, and a rotation handle 275 which rotates the spur gear 272. Furthermore, apart of the configuration of the rack and pinion 270 at the rear surface side is not illustrated in FIG. 20A, but all members except for the rotation handle 275 of the rack and pinion 270 at the front surface side may be provided in this way even at the rear surface side. Then, the shaft 273 is commonly used at the front surface side and the rear surface side, and the rotation amount of the spur gear 272, that is, the movement amount of the shaft holder 274 is the same at the front surface side and the rear surface side.

When the rotation handle 275 is rotated so that the spur gear 272 rotates to move on the rack gear 271, the shaft holder 274 also moves along with the spur gear 272, and the wheeled platform. 220 connected to the shaft holder 274 moves. When the spur gear 272 reaches the end of the rack gear 271 near the container 21, the shaft holder 274 is separated from the wheeled platform 220. The wheeled platform 220 further moves toward the container 21 so as to completely move from the ceiling plate placement table 230 to the container body 30.

Furthermore, in the case where the wheeled platform 220 moves from the container body 30 toward the ceiling plate placement table 230, the rack and pinion 270 is operated according to the procedure opposite to the above-described operation. Even in the lateral movement mechanism of this example, the wheeled platform 220 may accurately move on a desired path by the linear guides 250 and 260. Further, particularly when the ceiling plate 40 as a heavy object is placed on the wheeled platform 220 above the container body 30 and the wheeled platform 220 is moved toward the ceiling plate placement table 230, the wheeled platform 220 may be driven by the power of the rotation handle 275.

Furthermore, in the example of FIGS. 20A and 20B, the spur gear 272 is rotated by the manual rotation of the rotation handle 275, but the spur gear 272 may be rotated by a rotational power source such as a motor. Further, the manipulation force may be reduced by a decelerator or the like in response to the load of the ceiling plate. Further, in the above-described example, the linear guides 250 and 260 and the rack and pinion 270 are provided separately from the wheeled platform 220. However, the linear guide rails 251 and 261 may be set as the rack gears and the rolling body 221 may be set as the spur gear instead.

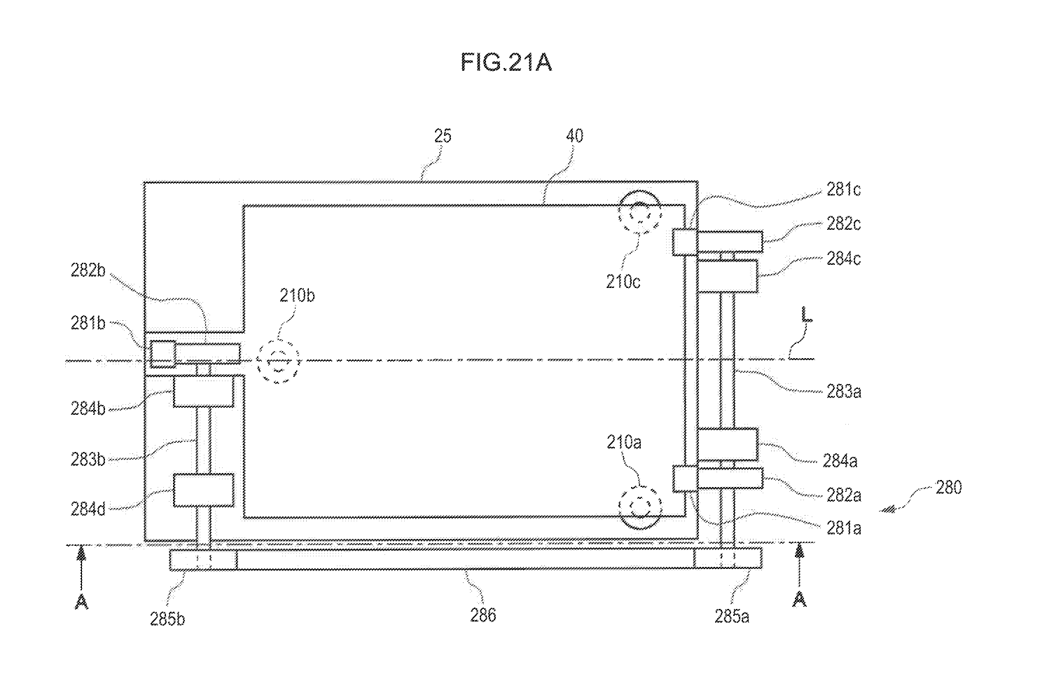

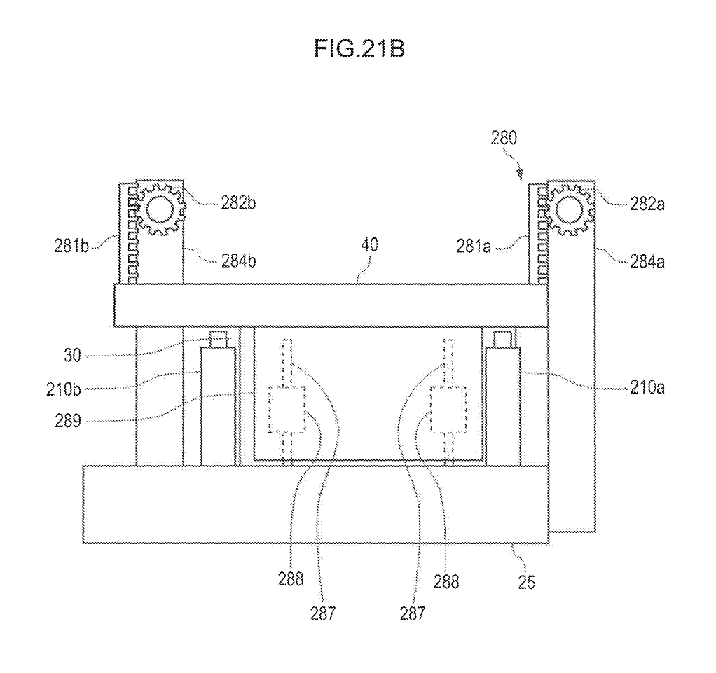

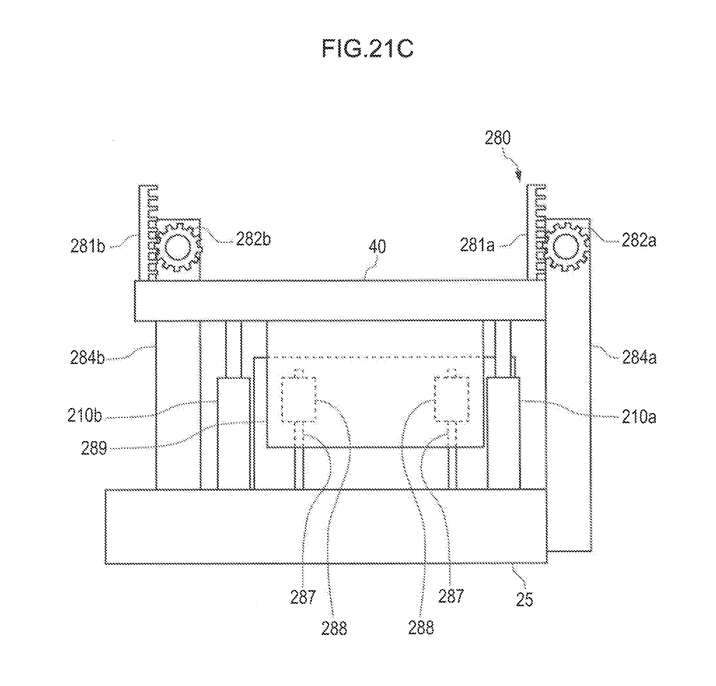

Next, a horizontal holding mechanism will be described which is used for the horizontal synchronization when the ceiling plate 40 is moved upward or downward by the jacks 210a to 210c in a support state. FIG. 21A is a top view illustrating the horizontal holding mechanism. FIGS. 21B and 21C are views taken along line A-A of FIG. 21A, FIG. 21B illustrates a downward movement state, and FIG. 21C illustrates an upward movement state.

The horizontal holding mechanism 280 includes rack gears 281a to 281c, spur gears (gears) 282a to 282c, and shaft holders 284a to 284c so as to correspond to the jacks 210a to 210c. The rack gears 281a to 281c are fixed to the ceiling plate 40, and move upward, downward, leftward, and downward along with the ceiling plate 40. The rack gears 281a to 281c all extend upward from the upper surface of the ceiling plate 40. In the rack gears 281a to 281c, gears are formed in a direction opposite to the ceiling plate placement table 230.

The shaft holders 284a to 284c are all uprightly formed on the surface plate 25. A shaft 283b is fixed to the rotation center of the spur gear 282b, and a common shaft 283a is fixed to the rotation centers of the spur gears 282a and 282c. The shaft 282b is rotatably supported by the shaft holders 284b and 284d. The shaft holders 284b and 284d support the shaft 284b so that the spur gear 282b fixed to the front end of the shaft 284b engages with the rack gear 281b in a direction opposite to the ceiling plate placement table 230 in the rack gear 281b. Further, the shaft 282a is rotatably supported by the shaft holders 284a and 284c. The shaft holders 284a and 284c support the shaft 284a so that the spur gears 282a and 282c fixed to the shaft 284a respectively engage with the rack gears 281a and 281c in a direction opposite to the ceiling plate placement table 230 in the rack gears 281a and 281c.

Pulleys 285a and 285b are respectively fixed to the front surface side ends of the shafts 283a and 283b. The pulley 285a and the pulley 285b are rotatably connected to each other by a timing belt 286.

Further, the horizontal holding mechanism includes a linear guide rail 287, a guide block 288, and a connection plate 289. The linear guide rail 287 is fixed to the container body 30. Two linear guide rails 287 are provided with a gap therebetween in the left and right direction. The linear guide rail 287 has a bar shape, and is provided so that the longitudinal direction faces the vertical direction. Furthermore, the linear guide rail 287 may be fixed to the surface plate 25. The guide block 288 moves on the linear guide rail 287 along the longitudinal direction of the linear guide rail 287. The guide block 288 is fixed to the connection plate 289.

The connection plate 289 is fixed to the lower side of the ceiling plate 40. That is, the connection plate 289 connects the ceiling plate 40 and the guide block 288 to each other, and uniformly maintains such a positional relation. Accordingly, since the posture of the left and right guide blocks 288 is maintained when the left and right guide blocks move upward and downward, the posture of the ceiling plate 40 may be maintained so that the ceiling plate 40 is not inclined due to the rotation about the shaft in the depth direction. Furthermore, in FIGS. 21B and 21C, an example has been described in which each linear guide rail 287 includes one guide block 288, but each linear guide rail 287 may be provided with a plurality of guide blocks 288 in the up and down direction. In this way, the posture of the connection plate 289 may be reliably maintained.

An operation of the horizontal holding mechanism with the above-described configuration will be described. The upward movement amounts of the jack 210a and the jack 210b are synchronized by the rack gear 281a and the spur gear 282a corresponding to the jack 210a, the rack gear 281b and the spur gear 282b corresponding to the jack 210b, and the shaft 283a, the pulley 285a, the timing belt 286, the pulley 285b, and the shaft 283b rotatably connecting the spur gear 282a and the spur gear 282b to each other, and hence the inclination of the ceiling plate 40 in the left and right direction is prevented.

That is, when the ceiling plate 40 moves upward by the jacks 210a to 210c, the rack gears 281a and 281b moves upward along with the ceiling plate 40. At this time, the spur gear 282a rotates by the number of revolutions in response to the upward movement amount of the rack gear 281a. The spur gear 282b also rotates by the number of revolutions in response to the upward movement amount of the rack gear 281b. Then, since the spur gear 282a and the spur gear 282b are synchronized with each other by the shafts 283a and 283b, the pulleys 285a and 285b, and the timing belt 286 so that the number of revolutions becomes uniform, the upward movement amounts of the rack gears 281a and 281b are equal to each other. Thus, when the ceiling plate 40 is moved upward, the jack 210a and the jack 210b are synchronized with each other so that the inclination of the ceiling plate 40 in the left and right direction is prevented.

Furthermore, the inclination of the ceiling plate 40 in the left and right direction is prevented even by the linear guide rail 287, the guide block 288, and the connection plate 289. That is, the connection plate 289 connects the ceiling plate 40 to two guide blocks 288, and uniformly maintains such a positional relation. Thus, since the posture of the left and right guide blocks 288 is restricted and maintained when the left and right guide blocks move upward and downward, the posture of the ceiling plate 40 is maintained so that the ceiling plate 40 is not inclined by the rotation about the shaft in the depth direction.

Further, the upward movement amounts of the jack 210a and the jack 210c are synchronized with each other by the rack gear 281a and the spur gear 282a corresponding to the jack 210a, the rack gear 281c and the spur gear 282c corresponding to the jack 210c, and the shaft 283a rotatably connecting the spur gear 282a and the spur gear 282c to each other, and hence the inclination of the ceiling plate 40 in the front to back direction (the depth direction) is prevented. However, since the support point sa of the jack 210a and the support point sc of the jack 210c are located at the line-symmetric positions with respect to the virtual line L as described above, the necessity for the synchronization of the upward movement amounts of the jack 210a and the jack 210c is low. Accordingly, the rack gear 281c and the spur gear 282c for the jack 210c may not be provided.

Here, the rack gears 281a to 281c fixed to the ceiling plate 40 are located near the ceiling plate placement table 230 with respect to the spur gears 282a to 282c fixed to the surface plate 25. For this reason, when the ceiling plate 40 which is horizontally held by the horizontal holding mechanism and is moved upward moves toward the ceiling plate placement table 230 while being placed on the wheeled platform 220, the engagement of the spur gears 282a to 282c with respect to the rack gears 281a to 281c is released, and the rack gears 281a to 281c move toward the ceiling plate placement table 230 along with the ceiling plate 40 while the spur gears 282a to 282c are left. On the contrary, when the ceiling plate 40 is returned to the container body 30, the rack gears 281a to 281c move from the ceiling plate placement table 230 toward the spur gears 282a to 282c along with the ceiling plate 40, and finally engage with the spur gears 282a to 282c.

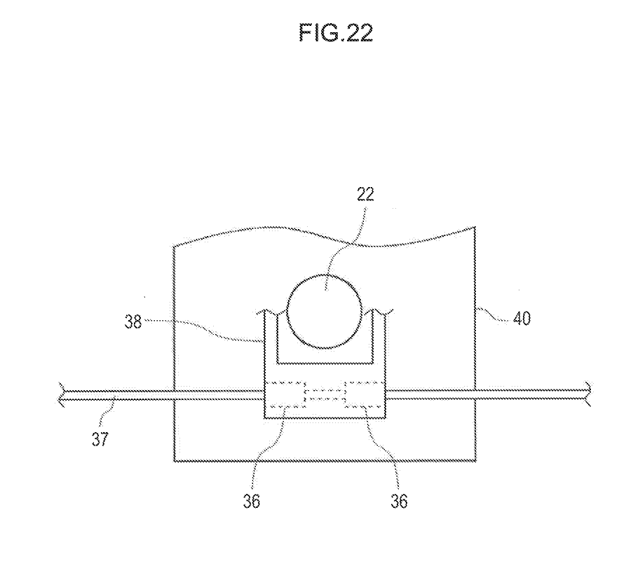

Next, a column movement support mechanism which supports the lateral movement of the column 22 as the ceiling plate upper structure with the lateral movement of the ceiling plate 40 and an auxiliary device movement mechanism which moves the auxiliary device 23 in the lateral direction in synchronization with the lateral movement of the column 22 will be described with reference to FIGS. 13 and 22. FIG. 22 is a top view of the column movement support mechanism. The column movement support mechanism includes a guide block 36 and a rail 37. The rail 37 is fixed to the inside of the housing 24 so that the longitudinal direction faces the left and right direction (the horizontal direction). The wire and the pipe connected to the column 22 are accommodated in the flexible cable bearer 27, and the wire and the pipe accommodated in the cable bearer 27 are connected to a necessary position of the other ceiling plate upper structure or the column 22 through the connection accommodation body 38 fixed to the guide block 36. A connection accommodation body 38 is provided with a gap with respect to the column 22 or the ceiling plate upper structure in the left and right direction. Thus, when the ceiling plate 40 moves in the lateral direction, the gap therebetween disappears, and the ceiling plate 40 and the column 22 move together in the lateral direction. That is, the guide block 36 moves along the rail 37 in the left and right direction.

The auxiliary device movement mechanism includes a guide block 39 and a rail 200. The guide block 39 is fixed to the lower side of the auxiliary device 23. The rail 200 is fixed to the upper surface of the housing 24 so that the longitudinal direction faces the left and right direction. The guide block 39 moves along the rail 200 in the left and right direction together with the auxiliary device 23.

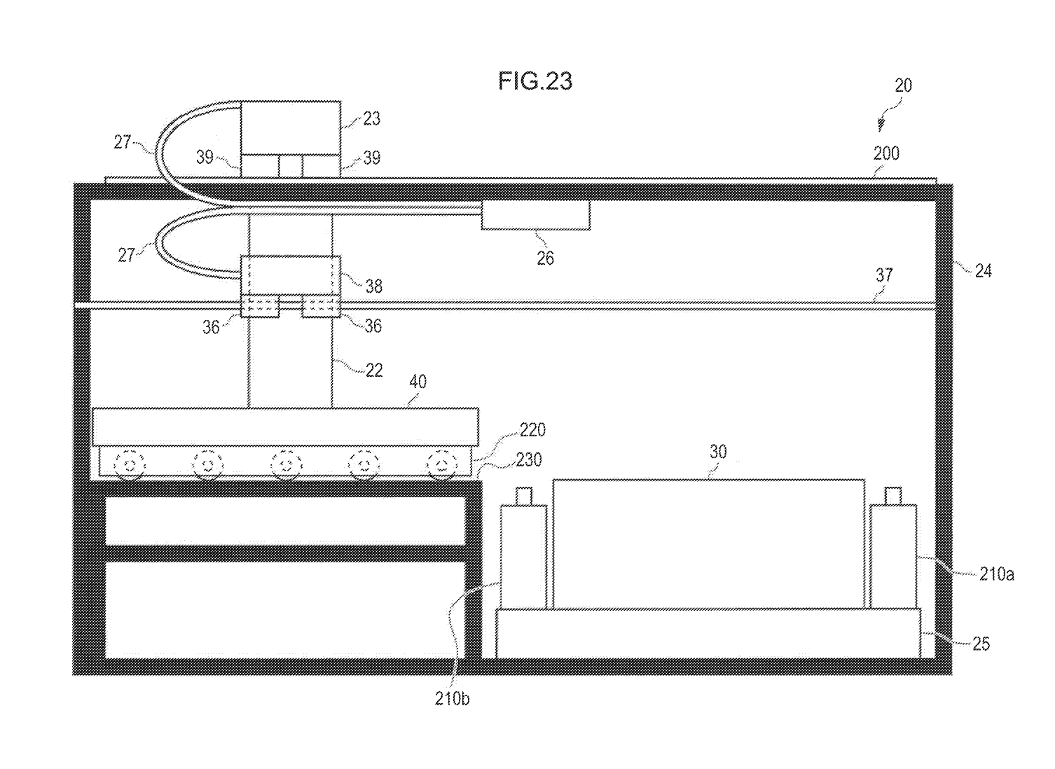

Next, the operations of the column movement support mechanism and the auxiliary device movement mechanism will be described. FIG. 23 is a diagram illustrating the operations of the column movement support mechanism and the auxiliary device movement mechanism. When the ceiling plate 40 is placed on the wheeled platform 220 and the ceiling plate 40 moves to the ceiling plate placement table 230 as illustrated in FIG. 23, the connection accommodation body 38 which connects the wire and the pipe to the column 22 on the ceiling plate 40 moves along with the column 22 and the ceiling plate 40 in a manner such that the guide block 36 slides on the rail 37 with the lateral movement of the ceiling plate 40.

At this time, since the accommodation box 26 is fixed to the housing 24, the accommodation box does not move even when the column 22 moves laterally. Since the wire and the pipe connecting the connection accommodation body 38 and the accommodation box 26 to each other are accommodated in the flexible cable bearer 27, the cable bearer 27 connecting the connection accommodation body 38 and the accommodation box 26 to each other is deformed with the movement of the connection accommodation body 38, and the wire and the pipe follows the movement of the connection accommodation body 38. Furthermore, the connection accommodation body 38 is provided so that a minute gap is formed with respect to the ceiling plate upper structure or the column in the left and right direction before the ceiling plate 40 moves laterally, and the connection accommodation body 38 contacts the ceiling plate upper structure or the column when the ceiling plate moves, so that the connection accommodation body moves along with the ceiling plate 40 and the column 22.

At this time, the guide block 39 fixed to the auxiliary device 23 slides on the rail 200 in synchronization with the lateral movement of the column 22 and the ceiling plate 40. Thus, the auxiliary device 23 moves laterally in synchronization with the lateral movement of the column 22 and the ceiling plate 40. Since the wire and the pipe connecting the auxiliary device 23 and the accommodation box 26 to each other are accommodated in the flexible cable bearer 27, the cable bearer 27 connecting the auxiliary device 23 and the accommodation box 26 to each other is deformed with the movement of the auxiliary device 23, and hence the wire and the pipe follows the movement of the auxiliary device 23.

Even when the ceiling plate 40 having the column 22 placed thereon is separated from the container body 30 and is moved to the ceiling plate placement table 230 by the operations of the column movement support mechanism and the auxiliary device movement mechanism, it is possible to smoothly open and close the ceiling plate 40 without separating the column 22 from the wire and the pipe. Further, since the wire and the pipe are evenly held by the flexible cable bearer 27, the wire and the pipe are not tangled even when the column 22 or the auxiliary device 23 move in the lateral direction.

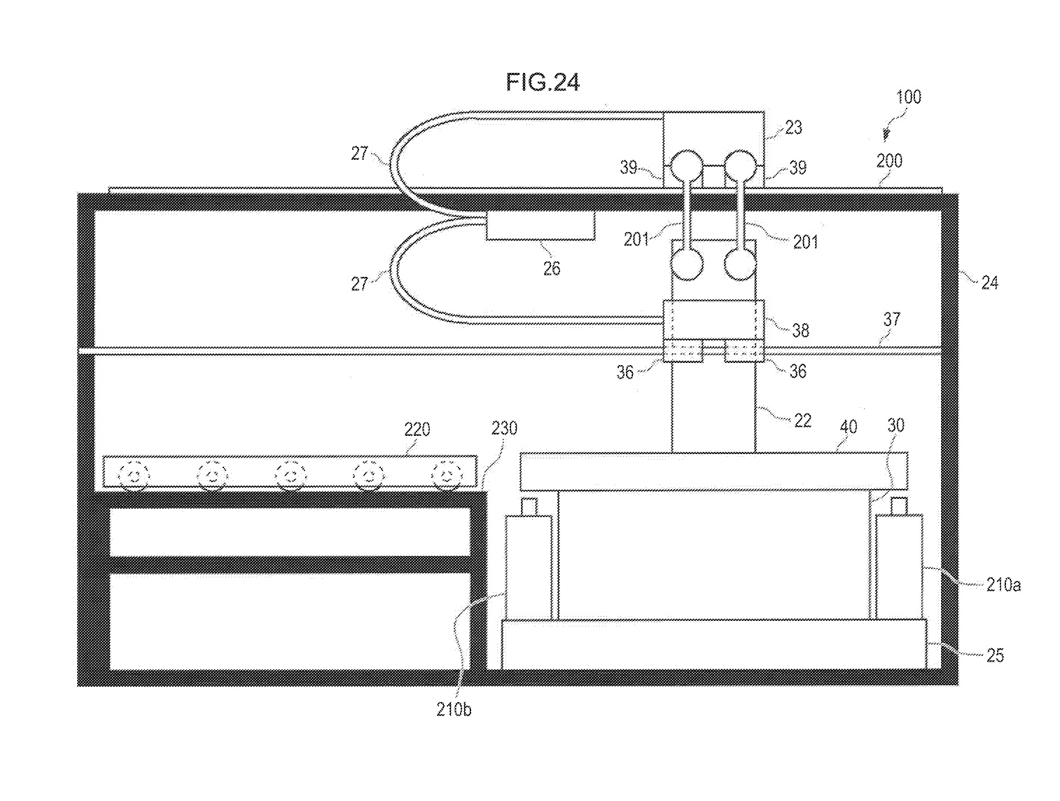

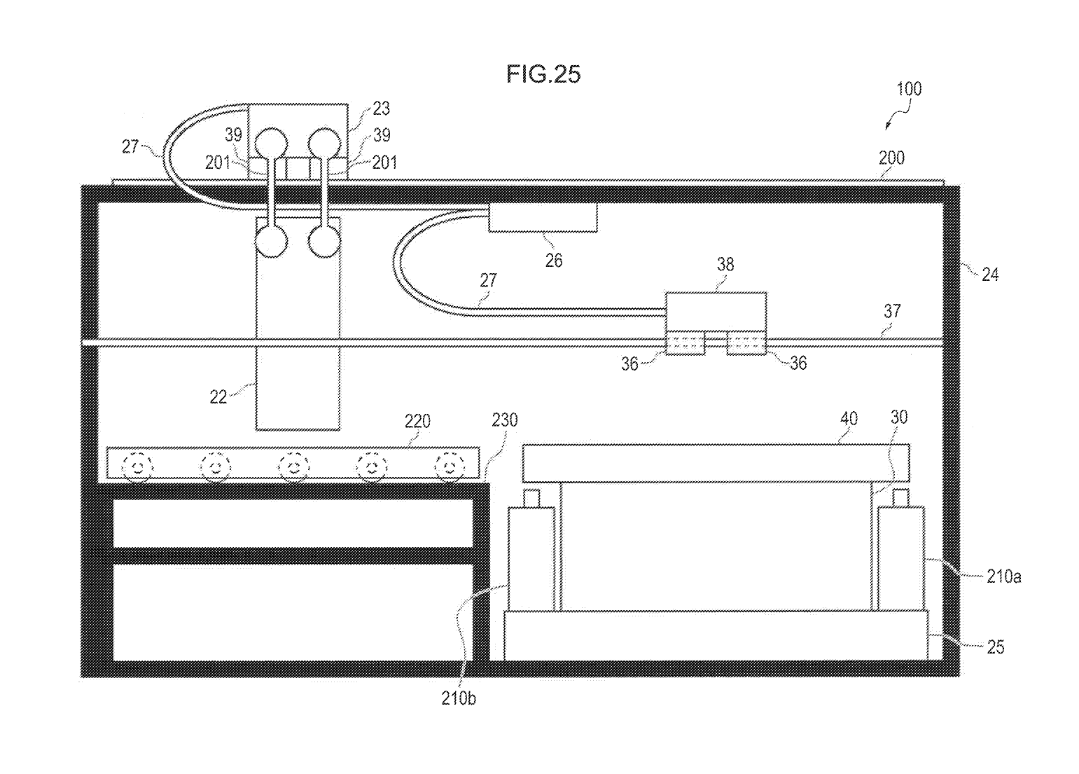

FIGS. 24 and 25 are front views illustrating a main configuration of an inspection device of a modified example. In the modified example, the column 22 is suspended by a swing member 201. The swing member 201 is provided so that the lower end is fixed to the column 22 and the upper end is fixed to the auxiliary device 23. The column 22 is movable in the lateral direction along with the auxiliary device 23. At this time, as illustrated in FIG. 25, the column 22 moves in the lateral direction independently from the connection accommodation body 38 and the guide block 36 supporting the accommodation body.

By such a configuration, the auxiliary device 23 and the column 22 are synchronized with each other, and may move in the lateral direction independently from the ceiling plate 40. As described in the above-described embodiments, the column 22 disposed on the ceiling plate 40 is a heavy object. Then, when the column moves along with the ceiling plate 40, a large driving force is needed for the movement of the ceiling plate 40. However, according to the modified example, the column 22 may be moved independently from the ceiling plate 40, and hence the repair or the maintenance of the column 22 may be easily performed. Furthermore, in the modified example, the connection accommodation body 38 and the guide block 36 are moved along with the ceiling plate 40 in the lateral direction when the ceiling plate 40 is placed on the wheeled platform 220 and is moved in the lateral direction. With such a configuration, a worker may easily access the upper surface of the container body 30 which is opened by the separation of the ceiling plate 40.

Further, in the above-described embodiments, as the horizontal holding mechanism that prevents the inclination in the left and right direction, a structure including the spur gears 282a and 282b, the shafts 283a and 283b, the pulleys 285a and 285b, and the timing belt 286 and a structure including the linear guide rail 287, the guide block 288, and the connection plate 289 are employed. However, only either of the two structures may be employed.

Further, in the above-described embodiments, the hydraulic jacks 210a to 210c are employed to move the ceiling plate 40 upward, but the other driving devices or mechanisms may be employed. Further, in the above-described embodiments, an example has been described in which the ceiling plate opening and closing mechanism is applied as the mechanism for opening and closing the ceiling plate of the vacuum container that accommodates the stage of the inspection device. However, the ceiling plate opening and closing mechanism may be also applied as the mechanism for opening and closing the ceiling plate of the other container.

Further, in the above-described embodiments, the ceiling plate 40 has a rectangular shape in the top view, but the ceiling plate 40 may have the other shapes. For example, the container body 30 has a cylindrical shape, and the ceiling plate 40 may have a circular shape in the top view.

In the embodiment, the ceiling plate is moved upward while being supported at three points, and hence the load of the ceiling plate is normally applied to all support points. Accordingly, it is possible to suppress behavior in which the ceiling plate is moved upward in an inclined state and hence to horizontally move the ceiling plate upward. Thus, the ceiling plate opening and closing mechanism may be suitably used as the mechanism for opening and closing the ceiling plate (the upper plate) of the container used in the semiconductor fabrication device that performs treatment on a target or the inspection device that inspects a target.

What is claimed is:

1. A reflecting mirror posture adjustment structure comprising:
a base that is obtained by integrally forming a fixed portion fixed onto an attachment table and a movable portion including a notched portion having a narrow width;
a reflecting mirror holder that holds a reflecting mirror and is fixed to the front end of the movable portion of the base; and
a gap width adjustment member that adjusts the width of the gap of the notched portion of the base,
wherein the inclining degree of the reflecting mirror held by the reflecting mirror holder is adjusted when the gap width of the notched portion is decreased or increased by the manipulation of the gap width adjustment member.

2. The reflecting mirror posture adjustment structure according to claim 1,
wherein the base includes at least a first movable portion in which a notched portion is disposed in a direction perpendicular to the lower surface of the fixed portion fixed onto the attachment table and a second movable portion in which a notched portion is disposed in a parallel direction.

3. The reflecting mirror posture adjustment structure according to claim 2,
wherein female tapered portions which are depressed downward are respectively provided in the facing surfaces inside the notched portion of the first movable portion, the gap width adjustment member of which the outer peripheral surface is provided with a male tapered portion fitted to the female tapered portions is fitted to the female tapered portions from the upside thereof, and a screw portion provided in the front end of the gap width adjustment member is threaded and fixed into a screw hole provided in an attachment table overlapping the lower side of the first movable portion, and
the gap width of the notched portion of the first movable portion is adjusted when the threading depth of the screw portion of the gap width adjustment member is changed.

4. The reflecting mirror posture adjustment structure according to claim 2 or 3,
wherein the second movable portion is formed by a lower movable piece and an upper movable piece facing the notched portion,
the upper surface of the upper movable piece is provided with the gap width adjustment member including a pulling bolt of which a shaft portion penetrates the upper movable piece and is threaded into a screw hole provided in the lower movable piece, a pushing bolt of which a shaft portion is threaded into a screw hole provided in the upper movable piece and the end of the shaft portion is bonded to the upper surface of the lower movable piece, and a fixing bolt which fixes the second movable portion in a manner such that a shaft portion penetrates the upper movable piece and the lower movable piece in the vicinity of the pulling bolt or the pushing bolt and is threaded into the screw hole provided in the attachment table overlapping the lower side of the second movable portion, and
the gap width of the notched portion of the second movable portion is adjusted when the threading depth of the pulling bolt of the gap width adjustment member in the lower movable piece and the threading depth of the pushing bolt thereof in the upper movable piece are changed.

5. The reflecting mirror posture adjustment structure according to claim 1,
wherein an access mechanism that includes a vacuum seal function and adjusts the gap width adjustment member is provided above the base, and
the inclining degree of the reflecting mirror provided in a vacuum state is adjusted by the manipulation of the access mechanism at the atmosphere side.

6. A ceiling plate opening and closing mechanism that opens and closes a rigid ceiling plate of a container including a container body and the ceiling plate, the ceiling plate opening and closing mechanism comprising:
an upward movement member that moves the ceiling plate upward while supporting the ceiling plate at three support points from the downside.

7. The ceiling plate opening and closing mechanism according to claim 6,
wherein the upward movement member corresponds to three hydraulic jacks that are operated by a common hydraulic pump and support the three support points of the ceiling plate from the downside.

8. The ceiling plate opening and closing mechanism according to claim 6, further comprising:
a lateral movement mechanism that laterally moves the ceiling plate moved upward by the upward movement member.

9. The ceiling plate opening and closing mechanism according to claim 8,
wherein the lateral movement mechanism includes a ceiling plate placement table that places the moved ceiling plate thereon while being adjacent to the container body, and the ceiling plate is movable onto the ceiling plate placement table.

10. The ceiling plate opening and closing mechanism according to claim 8,
wherein the lateral movement mechanism includes a wheeled platform that places the ceiling plate thereon and moves in the lateral direction, and
the wheeled platform is inserted below the ceiling plate moved upward by the upward movement member and the ceiling plate is moved downward so as to place the ceiling plate on the wheeled platform.

11. The ceiling plate opening and closing mechanism according to claim 10,
wherein the wheeled platform includes a rolling body.

12. The ceiling plate opening and closing mechanism according to claim 6,
wherein the ceiling plate has a line-symmetric shape with respect to a predetermined virtual line, and two support points among the three support points are also located at the line-symmetric positions with respect to the predetermined virtual line.

13. The ceiling plate opening and closing mechanism according to claim 12, further comprising:
a horizontal holding mechanism that synchronizes the upward movement amount of the ceiling plate at the two support points and the other one support point.

14. The ceiling plate opening and closing mechanism according to claim 13,
wherein the horizontal holding mechanism includes a plurality of rack gears that is fixed to the ceiling plate and a spur gear that engages with each of the plurality of rack gears and is fixed to one rotatable shaft fixed to the container body, and the inclination of the ceiling plate is corrected when the spur gear engaging with each of the plurality of rack gears is rotated with the upward movement of the ceiling plate.

15. The ceiling plate opening and closing mechanism according to claim 6,
wherein a structure is placed on the ceiling plate, and
the ceiling plate opening and closing mechanism further includes a structure movement support mechanism that supports the movement of the structure with the movement of the ceiling plate.

16. The ceiling plate opening and closing mechanism according to claim 15,
wherein an auxiliary device provided in the structure is connected to the structure, and
the ceiling plate opening and closing mechanism further includes an auxiliary device movement mechanism that moves the auxiliary device in synchronization with the movement of the structure.

17. The ceiling plate opening and closing mechanism according to claim 16,
wherein the structure and the auxiliary device are connected to each other by a wire and/or a pipe,
the ceiling plate opening and closing mechanism further includes an accommodation box that accommodates the wire and/or the pipe and does not move even when the structure and the auxiliary device move, and
the wire and/or the pipe is accommodated in a flexible cable bearer.

18. The ceiling plate opening and closing mechanism according to claim 12,
wherein the wire and/or the pipe is connected to the structure through a connection accommodation body.

19. The ceiling plate opening and closing mechanism according to claim 6,
wherein a structure is placed on the ceiling plate, and
the ceiling plate opening and closing mechanism further includes a structure movement support mechanism that moves a part of the structure independently from the movement of the ceiling plate.

20. An inspection device that detects an inspection target, comprising:
a container that includes a container body accommodating the inspection target and a ceiling plate;
a column that is provided on the ceiling plate and irradiates the inspection target accommodated in the container with a beam; and
a ceiling plate opening and closing mechanism that opens and closes the ceiling plate,
wherein the ceiling plate opening and closing mechanism includes an upward movement member that moves the ceiling plate upward while supporting the ceiling plate at three support points from the downside.
